(19) United States
(12) Patent Application Publication
(10) Pub. No.: US 2024/0394630 A1
(43) Pub. Date: Nov. 28, 2024

(54) INFORMATION PROCESSING APPARATUS, TASK MANAGEMENT SYSTEM, INFORMATION PROCESSING METHOD, AND RECORDING MEDIUM

(71) Applicant: NEC Corporation, Minato-ku, Tokyo (JP)

(72) Inventors: Akihisa SUDOU, Tokyo (JP); Daisuke KAWASAKI, Tokyo (JP); Kaori YAMANE, Tokyo (JP)

(73) Assignee: NEC Corporation, Minato-ku, Tokyo (JP)

(21) Appl. No.: 18/695,396

(22) PCT Filed: Sep. 30, 2021
(86) PCT No.: PCT/JP2021/036206

§ 371 Date: Mar. 26, 2024

(51) Int. Cl. G06Q 10/0631; G06V 40/16; G07C 5/00; G07C 5/08

(52) U.S. Cl. CPC G06Q 10/06316; G06V 40/161; G07C 5/008; G07C 5/0816

(57) ABSTRACT

An information processing apparatus includes: a manager information acquisition unit that acquires manager reliability information indicating reliability of a manager who performs a roll call; and an identification unit that identifies a manager who actually performs the roll call, as a caller, on the basis of the manager reliability information.

### TECHNICAL FIELD

This disclosure relates to technical fields of an information processing apparatus, a task f r management system, an information processing method, and a recording medium that supports management/administration of execution of tasks.

### BACKGROUND ART

Patent Literature 1 describes an example of a roll call system in which, even when a caller who performs a roll call is away from a callee who receives the roll call, or who is called, the callee is properly called. Patent Literature 1 describes that a callee-side apparatus includes: an authentication apparatus that performs authentication of the callee, a sphygmomanometer that measures blood pressure of the callee, an acceleration pulse wave meter that measures acceleration pulse wave of the callee, a body surface thermometer that measures body surface temperature of the callee, and an alcohol measuring instrument that measures expiration alcohol concentration of the callee. Furthermore, Patent Literature 1 describes that a history, such as past traffic violations, sickness, and a past work history, is registered in advance for each callee and is displayed on a monitor of the callee-side apparatus.

Furthermore, Patent Literature 2 describes an example of a roll call system in which it is possible to preferentially process a roll call of a callee who would like to be preferentially called.

### CITATION LIST

### Patent Literature

Patent Literature 1: JP2011-238059A
Patent Literature 2: JP2012-123433A

### SUMMARY

### Technical Problem

It is an example object of this disclosure to provide an information processing apparatus, an information processing method, and a recording medium that are intended to improve the techniques/technologies described in Citation List.

### Solution to Problem

An information processing apparatus according to an example aspect of this disclosure includes: a manager information acquisition unit that acquires manager reliability information indicating reliability of a manager who performs a roll call; and an identification unit that identifies a manager who actually performs the roll call, as a caller, on the basis of the manager reliability information.

A task management system according to an example aspect of this disclosure includes: a callee terminal including a communication unit that communicates with an external apparatus, and an image generation unit that generates a current face image of a callee by imaging the callee: an information processing apparatus including a communication unit that communicates with an external apparatus, an image acquisition unit that acquires the current face image of the callee from the image generation unit through the communication unit, and the above information processing apparatus; and a manager terminal including a communication unit that communicates with an external apparatus, and a display that is controlled by the display control unit through the communication unit and that displays a screen for the manager.

An information processing method according to an example aspect of this disclosure includes: acquiring manager reliability information indicating reliability of a manager who performs a roll call; and identifying a manager who actually performs the roll call, as a caller, on the basis of the manager reliability information.

A recording medium according to a first aspect of this disclosure is a recording medium on which a computer program that allows a computer to execute an information processing method is recorded, the information processing method including: acquiring manager reliability information indicating reliability of a manager who performs a roll call; and identifying a manager who actually performs the roll call, as a caller, on the basis of the manager reliability information.

### BRIEF DESCRIPTION OF DRAWINGS

FIG. 1 is a block diagram illustrating a configuration of an information processing apparatus according to a first example embodiment.

FIG. 2 is a block diagram illustrating a configuration of an information processing apparatus according to a second example embodiment.

FIG. 3 is a flowchart illustrating a flow of a caller assignment operation performed by the information processing apparatus according to the second example embodiment.

FIG. 4 is a flowchart illustrating a flow of the caller assignment operation performed by an information processing apparatus according to a third example embodiment.

FIG. 5 is a block diagram illustrating a configuration of an operating management system according to a fourth example embodiment.

FIG. 6 is a diagram illustrating a flow of an operating management operation performed by the operating management system according to the fourth example embodiment.

FIG. 7 is a block diagram illustrating a configuration of an information processing apparatus according to a fourth example embodiment.

FIG. 8 is a diagram illustrating an example of a display in a manager terminal in the fourth example embodiment.

FIG. 9 is a flowchart illustrating a flow of a roll call support operation performed by the information processing apparatus according to the fourth example embodiment.

FIG. 10 is a block diagram illustrating a configuration of an information processing apparatus according to a fifth example embodiment.

FIG. 11 is a flowchart illustrating a flow of the roll call support operation performed by the information processing apparatus according to the fifth example embodiment.

FIG. 12 is a diagram illustrating a flow of the operating management operation performed by the operating management system according to the fifth example embodiment.

FIG. 13 is a flowchart illustrating a flow of the roll call support operation performed by an information processing apparatus according to a sixth example embodiment.

FIG. 14 is a block diagram illustrating a configuration of an information processing apparatus according to a seventh example embodiment.

FIG. 15 is a diagram illustrating a flow of a pre-duty operating management operation performed by an information processing apparatus according to an eighth example embodiment.

FIG. 16 is a diagram illustrating a flow of an on-duty operating management operation performed by the operating management system according to the eighth example embodiment.

FIG. 17 is a diagram illustrating an example of a display in a manager terminal in the eighth example embodiment.

FIG. 18 is a block diagram illustrating a configuration of an information processing apparatus according to a ninth example embodiment.

FIG. 19 is a flowchart illustrating a flow of a manager reliability calculation operation performed by the information processing apparatus according to the ninth example embodiment.

### DESCRIPTION OF EXAMPLE EMBODIMENTS

Hereinafter, with reference to the drawings, an information processing apparatus, a task management system, an information processing method, and a recording medium according to example embodiments will be described with reference to the drawings.

### (1) First Example Embodiment

First, an information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

FIG. 1 is a block diagram illustrating a configuration of the information processing apparatus 1 according to the first example embodiment. As illustrated in FIG. 1, an information processing apparatus 1 includes a manager information acquisition unit 11 and an identification unit 12.

The manager information acquisition unit 11 acquires manager reliability information indicating reliability of a manager/administrator who performs a roll call. The identification unit 12 identifies a manager who actually calls the roll, as a caller, on the basis of the manager reliability information.

The roll call may be such that the manager receives and confirms a report of daily inspection from a callee, or a report about a health condition of the callee or the presence or absence of an influence of alcohol on the callee, and that the manager gives instructions necessary to ensure safety against it. The roll call may include a pre-duty roll call performed when the callee intends to work for the first time on the day, and a post-duty roll call performed when the callee finishes a day's work. The roll call may be performed in a face-to-face or remote state. Here, the manager may be a person who manages execution of tasks.

The roll call performed in the face-to-face state (hereinafter referred to as a face-to-face roll call) may refer to a roll call performed in a state in which the manager and the callee are close enough to keep a social distance. The roll call performed in the remote state (hereinafter referred to as a remote roll call) may also refer to a roll call performed in a state in which the manager and the callee are physically separated and are connected by a network such as a communication line. The roll call performed in the remote state may be a roll call performed for a driver in another business office, and may be performed through a roll call device, for example. As the roll call device, a device that provides driver information required for the roll call may be used. The information processing apparatus 1 according to the first example embodiment may be used for a roll call performed in one of the face-to-face state and the remote state.

The execution of tasks shall be managed by the manager. For example, at the start and end of work, the manager may perform a roll call of an operator who performs tasks. The manager may judge whether or not the operator can perform tasks properly by the roll call, and when the operator can perform tasks properly, the manager may permit the operator to start to work.

Each manager has a different roll call capability. It is preferable to identify the manager who can more properly perform a roll call, as the caller, with respect to the roll call scheduled to be performed. The tasks may be properly performed by an appropriate caller who performs a roll call. Therefore, in the first example embodiment, the caller who actually performs a roll call is identified on the basis of the reliability of the manager.

The information processing apparatus 1 according to the first example embodiment identifies the manager who actually performs a roll call, as the caller, on the basis of the reliability of the manager who performs a roll call. That is, in the first example embodiment, a concept of the reliability of the manager is introduced, and the information processing apparatus 1 identifies an appropriate manager as the caller, on the basis of the reliability of the manager. Therefore, the information processing apparatus 1 according to the first example embodiment is capable of supporting the realization of execution of an appropriate roll call by an appropriate manager, and is capable of supporting appropriate management of execution of tasks.

### (2) Second Example Embodiment

Next, an information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### (2-1) Configuration of Information Processing Apparatus 2

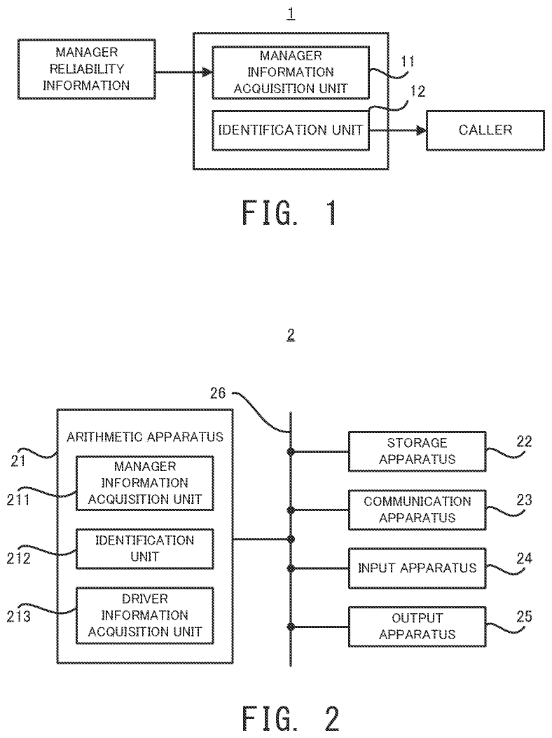

First, with reference to FIG. 2, a configuration of the information processing apparatus 2 according to the second example embodiment will be described. FIG. 2 is a block diagram illustrating the configuration of the information processing apparatus 2 according to the second example embodiment. In the following description, the components already described carry the same reference numerals, and a detailed description thereof will be omitted.

As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25.

The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by the information processing apparatus 2 is realized or implemented in the arithmetic apparatus 21. That is, the arithmetic apparatus 21 is allowed to function as a controller for realizing or implementing the logical functional block for performing an operation (in other words, a process) to be performed by the information processing apparatus 2.

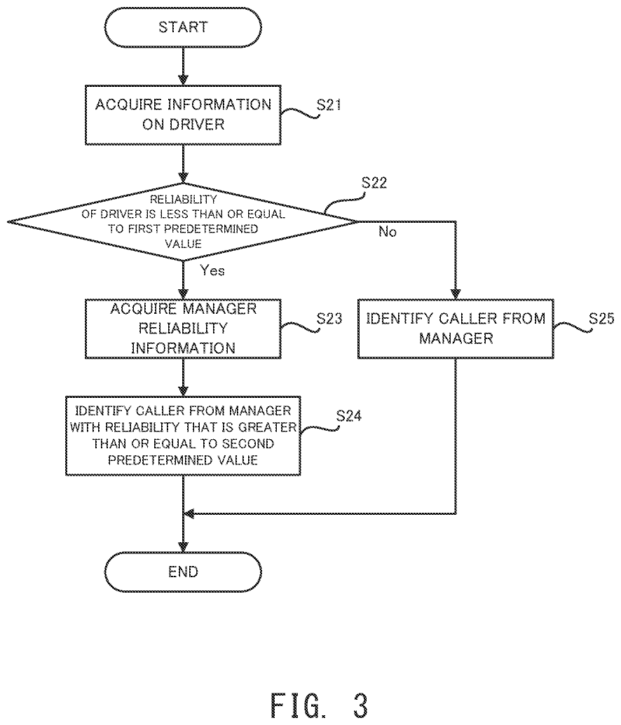

FIG. 2 illustrates an example of the logical functional block realized or implemented in the arithmetic apparatus 21 to perform a caller assignment operation. As illustrated in FIG. 2, a manager information acquisition unit 211 that is a specific example of the “manager information acquisition unit”, an identification unit 212 that is a specific example of the “identification unit,” and a driver information acquisition unit 213 that is a specific example of the “driver information acquisition unit” are realized or implemented in the arithmetic apparatus 21. The details of operation of each of the manager information acquisition unit 211, the identification unit 212, and the driver information acquisition unit 213 will be described in detail later with reference to FIG. 3. The arithmetic apparatus 21, however, may not include the driver information acquisition unit 213.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium.

The communication apparatus 23 is configured to communicate with an apparatus external to the information processing apparatus 2 through a not-illustrated communication network.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output the information as an image. That is, the output apparatus 25 may include a display apparatus (a so-called display) that is configured to display an image indicating the information that is desirably outputted. For example, the output apparatus 25 may output information as audio. That is, the output apparatus 25 may include an audio apparatus (a so-called speaker) that is configured to output audio. For example, the output apparatus 25 may output information onto a paper surface. That is, the output apparatus 25 may include a print apparatus (a so-called printer) that is configured to print desired information on the paper surface.

In the second example embodiment, the tasks to be performed may be operation of a vehicle, such as a bus, a truck, a freight vehicle, and a taxi, and the callee may be a driver who drives the vehicle. The information processing apparatus 2 may be an apparatus that is used by a vehicle operation company and that supports a roll call of the driver who drives the vehicle.

The manager for the operation of the vehicle is a person who performs various tasks for the proper operation of the vehicle. The main tasks of the manager may be tasks about duties of the driver, and may be operating management including: (1) understanding the health condition of the driver, (2) managing working hours of the driver, (3) guiding/teaching the driver, (4) operation monitoring, or the like.

(1) In order to safely and smoothly operate the vehicle, it is essential that the mind and body of the driver be healthy. Therefore, the manager may confirm, understand, record, and manage the health condition of the driver in the roll call. The roll call is preferably performed both before and after the duties, but the timing of the roll call is not limited.

(2) The manager performs task assignment/task sharing of the driver in a range of working hours stipulated by law; and the driver performs tasks in accordance with the task assignment. The driver may record a time such as before and after the duties, a rest, and a nap, and the manager may check whether the driver keeps predetermined working hours and whether the driver takes a rest or the like in proper quantities. Furthermore, distance, time, and location in which a driving vehicle travels, may be recorded and managed.

(3) The manager may provide guidance on the driver's driver And customer service, or the like. The manager may provide all the drivers with general guidance on their knowledge/mindset to drive the vehicle. In addition, the manager may provide specific guidance for a specific driver, such as a “newly appointed driver,” an “accident-causing driver,” and an “elderly driver,” for example. The accident-causing driver refers to a driver who has caused a traffic accident. The manager may guide/teach the newly appointed driver to acquire safety driving skills, for example. The manager may provide the accident-causing driver with guidance for preventing the accident from recurring, for example. The manager may guide/teach the elderly driver how to carry out appropriate driving even though the physical functions such as judgement ability are deteriorated.

(4) The manager may confirm a current operation status and may confirm a delay of the vehicle and the presence or absence of an accident.

In addition, when the driver of whom the manger is in charge causes an accident or receives a complaint, the manager may give advice on settlement to the driver, or may enter into settlement process between both relevant parties. Accordingly, it is advisable to assign a manager who is capable of responding to an accident or complaint, to a driver who is likely to be involved in an accident or complaint. Preferably; the manager who responds to an accident or complaint is able to understand a situation, is able to properly judge where responsibility lies, and does not give disadvantages to the company.

### (2-2) Caller Assignment Operation Performed by Information Processing Apparatus 2

Subsequently, with reference to FIG. 3, a caller assignment operation performed by the information processing apparatus 2 according to the second example embodiment will be described. FIG. 3 is a flowchart illustrating a flow of the caller assignment operation performed by the information processing apparatus 2 according to the second example embodiment.

As illustrated in FIG. 3, the driver information acquisition unit 213 acquires driver information on a driver concerned (step S21). The driver information includes at least driver reliability information indicating reliability of the driver concerned, and the driver information acquisition unit 213 acquires the driver reliability information indicating the reliability of the driver, as callee reliability information indicating the reliability of the driver as the callee who receives a roll call, or who is called. In the second example embodiment, the identification unit 212 assigns the manager as the caller, to the driver, on the basis of the manager reliability information and the driver reliability information.

For example, in a case where the driver information is stored in the storage apparatus 22, the acquisition unit 213 may acquire the driver information from the storage apparatus 22. For example, in a case where the driver information is stored on a recording medium that is externally attachable to the information processing apparatus 2, the driver information acquisition unit 213 may acquire the driver information from the recording medium by using the recording medium reading apparatus provided in the information processing apparatus 2 (e.g., the input apparatus 24). For example, in a case where the driver information is stored in an external apparatus of the information processing apparatus 2 (e.g., a cloud server), the driver information acquisition unit 213 may acquire the driver information from the external apparatus by using the communication unit 23. The driver reliability information included in the driver information may be calculated in advance, or may be calculated in accordance with the start of the operation.

Next, the identification unit 212 determines whether or not the reliability of the driver is less than or equal to a first predetermined value, by using the driver reliability information out of the driver information acquired in the step S21 (step S22). As a result of the determination in the step S22, when the reliability of the driver is less than or equal to the first predetermined value (the step S22: Yes), the manager information acquisition unit 211 acquires manager reliability information indicating the reliability of the manager who performs a roll call of the driver (step S23). Subsequently, the identification unit 212 identifies the manager with the reliability that is greater than or equal to a second predetermined value, as the caller who actually performs a roll call of the driver, by using the manager reliability information (step S24). That is, when the reliability of the driver as the callee is less than or equal to the first predetermined value, the identification unit 212 assigns the manager with the reliability that is greater than or equal to the second predetermined value, as the caller, to the driver.

### (Reliability of Manager)

The reliability of the manager may be calculated on the basis of a task execution management performance of the manager concerned. The task execution management performance of the manager concerned may include roll call achievements of the manger in the past. For example, the task execution management performance may be high in a case where the driver who receives a roll call from the manager can finish a task without causing trouble such as an accident. That is, the reliability of the manager may be high in a case where the manager permits the driver to start to work after judging that the driver will not cause a problem and the driver actually does not cause a problem, and in a case where an appropriate roll call is performed. In other words, in a case where the reliability of the manager is calculated on the basis of the roll call achievements of the manager in the past, the reliability of the manager may vary depending on driving performance of the driver who receives a roll call. For example, the reliability of the manager may be increased if the driver does not cause a problem, and may be reduced if the driver causes a problem. In other words, the task execution management performance of the manager may vary depending on the reliability of the driver. In addition, the reliability of the manager may vary depending on the reliability of the driver. If the driver does not cause a problem, the reliability of the manager may be changed to be high, but if the driver causes a problem, the reliability may not be changed actively. Conversely, if the driver causes a problem, the reliability of the manager may be changed to be low; but if the driver does not cause a problem, the reliability may not be changed actively.

A driver who frequently causes a problem, however, is more likely to cause a problem compared with other drivers even if the driver receives a roll call from a manager who has a good management performance. For this reason, when the manager with good management performance and high-reliability performs a roll call of the driver who frequently causes a problem, the reliability of the manager may not be lowered even if the driver concerned causes a problem, in comparison with a case where another driver causes a problem.

On the other hand, the reliability of the manager may be calculated in accordance with a working status of the manager, regardless of task performance of the driver. For example, the reliability of a manager with long service may be calculated to be high. In addition, the reliability of the manager may be calculated on the basis of whether or not the manager had trouble with the driver in the past, for example.

The reliability of the manager may be calculated on the basis of evaluation by the driver. For example, the reliability of the manager may be calculated to be high in a case where the driver gives a high evaluation, such as “a manager capable of performing a roll call in a short time.” “a manager capable of providing accurate guidance,” and “a manager of sense”. In a case where the reliability of the manager is calculated on the basis of the evaluation by the driver, a point to be evaluated may be prepared in advance. In addition, in a case where the reliability of the manager is calculated on the basis of the evaluation by the driver, a manager who receives many evaluation points from the driver may be judged to be highly evaluated, and the reliability may be calculated to be high.

According to the calculation method described above, the reliability of the manager is not a fixed index, but is an ever-changing index. For example, the reliability of the manager may be calculated and updated at the end of a day's work. In this case, the reliability of the manager changes every day. On the other hand, in a case where at least one of the manager and the driver who receives a roll call from the manager causes a serious problem, recalculation may be performed so as to be immediately reflected in the reliability of the manager.

In the second example embodiment, the reliability of the manager is an index used only when the manager is identified as the caller, and is preferably information that is not disclosed especially to the driver. This is because the driver is expected to avoid receiving a roll call from a less reliable manager.

### (Reliability of Driver)

The driver who requires the manager's attention in letting him/her to drive the vehicle, such as the accident-causing driver and the newly appointed driver with a short driving history, should receive a careful roll call that is not simple. Therefore, in the second example embodiment, the reliability of the driver is introduced as an index for determining whether or not the driver should receive a careful roll call that is not simple, and the reliability of the driver who requires the attention is calculated to be low: The driver may receive a roll call from the manager who can perform a careful roll call that is not simple, in a cased where the reliability is low. That is, the driver may receive a roll call from the manager who can perform a highly effective roll call, in a cased where the reliability of the driver is low:

The reliability of the driver may be calculated on the basis of the driving performance of the driver who receives a roll call. For example, the reliability of the driver may be calculated in accordance with past accident cases of the driver. In this case, the reliability may be calculated to be high when the driver has few past accident cases, and the reliability may be calculated to be low when the driver has many past accident cases. Therefore, the reliability of the driver with a high rate of the execution of tasks without an accident may be calculated to be high. In addition, a degree to which the reliability is raised or lowered, may be changed in accordance with a degree of importance of the accident caused by the driver.

The reliability of the driver may be calculated in accordance with a driving history of the driver. For example, in a case where the driving history is long, the reliability of the driver may be calculated to be high, and in a case where the driving history is short, the reliability of the driver may be calculated to be low:

In addition, the reliability of the driver may be calculated in accordance with a working attitude of the driver. For example, in a case where an absenteeism rate is low; the reliability of the driver may be calculated to be high, and in a case where the absenteeism rate is high, the reliability of the driver may be calculated to be low:

According to the calculation method described above, the reliability of the driver is not a fixed index, but is an ever-changing index. For example, the reliability of the driver may be updated at the end of a day's work. The reliability of the driver changes every day. On the other hand, in a case where the driver causes a serious problem, recalculation may be performed so as to be immediately reflected in the reliability of the driver.

Furthermore, the reliability of the driver may be calculated in accordance with the task assignment/task sharing. For example, in a case where the driver, who is usually in charge of tasks in the morning, is in charge of tasks at night, the reliability at the execution of tasks may be calculated to be low. This is because it is considered to require a careful roll call that is not simple, as the tasks are performed in a time zone that is different from usual. Alternatively, in a case where the driver is in charge of a region or route that is different from usual, the reliability at the execution of tasks may be calculated to be low. This is because it is considered to require a careful roll call that is not simple, as the tasks are performed in an environment that is different from usual. That is, even if the driver has few past accident cases, has a long driving history, and has a good working attitude, the reliability of the driver concerned may be calculated to be low in a case where the working hours, workplace, and the like are different from usual. Conversely, since it is in the environment that is different from usual, it can be expected that the driver performs tasks more carefully than usual and that a problem of an accident or other problems are less likely to occur.

In the step S24, when there are a plurality of managers with the reliability that is greater than or equal to the second predetermined value, the identification unit 212 may randomly identify the manager as the caller from among the plurality of managers, for example. Furthermore, for example, the identification unit 212 may identify the most reliable manager as the caller from among the plurality of managers. In addition, for example, the identification unit 212 may identify a manager who have not been assigned to the driver concerned for the longest time since the last time, as the caller, from among the plurality of managers. Furthermore, for example, the identification unit 212 may identify the manager who has been assigned to the driver concerned the fewest number of times, as the caller, from among the plurality of managers.

On the other hand, as a result of the determination in the step S22, when the reliability of the driver exceeds the first predetermined value (the step S22: No), the identification unit 212 identifies the caller who actually performs a roll call of the driver, from the manager (step S25). The identification unit 212 may randomly identify the manager as the caller from among the plurality of managers, for example. Furthermore, for example, the identification unit 212 may identify the most reliable manager as the caller from among the plurality of managers. In addition, for example, the identification unit 212 may identify the manager who have not been assigned to the driver concerned for the longest time since the last time, as the caller, from among the plurality of managers. Furthermore, for example, the identification unit 212 may identify the manager who has been assigned to the driver concerned the fewest number of times, as the caller, from among the plurality of managers.

As described above, the identification unit 212 may not always assign the caller to the driver on the basis of the reliability of the manager, and may perform assignment of the caller based on the reliability of the manager, only to the driver with lower reliability, such as the accident-causing driver.

The second example embodiment describes an automobile as a target of the operating management, but the target of the operating management is not limited to the automobile. The target of the operating management may be a vehicle such as a car, a train, a subway, a motorcycle, and a bicycle, an aircraft such as an airplane, a helicopter, and a drone, a vessel such as a transportation tanker, and a ferry; or the like. Furthermore, the caller may be a pilot/operator who navigates/operates these vehicles. The information processing apparatus 2 may be an apparatus that is used by a vehicle operation company and that supports a roll call of the pilot/operator who navigates/operates the vehicle.

Furthermore, the information processing apparatus 2 may be used not only for a roll call in the operation of the vehicle, but also for a roll call in working at a factory, a roll call in luggage control in a warehouse, and the like. The information processing apparatus 2 according to the second example embodiment is applicable to any business/work/task in which a roll call is performed.

### (2-3) Technical Effect of Information Processing Apparatus 2

As described above, in the information processing apparatus 2 according to the second example embodiment, a single manager is assigned to the driver, as the caller who actually performs a roll call of the driver, on the basis of the reliability of the driver as the target callee, in addition to the reliability of the manager. Which manager is an appropriate caller is different for each driver, but the information processing apparatus 2 according to the second example embodiment is capable of supporting the realization of execution of an appropriate roll call by a manager who is suitable for the driver, and is capable of supporting the appropriate management of execution of tasks.

In particular, it is desirable that the driver who may cause a problem receives a roll call from a more reliable manager. As described above, in the information processing apparatus 2 according to the second example embodiment, when the reliability of the driver as the callee who receives a roll call is less than or equal to the first predetermined value, the manager with the reliability that is greater than or equal to the second predetermined value, is assigned as the caller to the driver concerned. Therefore, the information processing apparatus 2 according to the second example embodiment is capable of supporting the realization of execution of an appropriate roll call by the manager who is suitable for the driver, and is capable of supporting the appropriate management of execution of tasks, as in the information processing apparatus 1 according to the first example embodiment.

### (3) Third Example Embodiment

Next, an information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

The information processing apparatus 3 according to the third example embodiment is different from the information processing apparatus 2 according to the second example embodiment, in the allocation of the manager to the driver by the identification unit 212. In addition, the storage apparatus 22 stores, as the driver information, callee history information indicating when and from which manager the driver concerned received a roll call from the manager in the past. Other features of the information processing apparatus 3 may be the same as those of the information processing apparatus 2.

### (3-1) Caller Assignment Operation Performed by Information Processing Apparatus 3

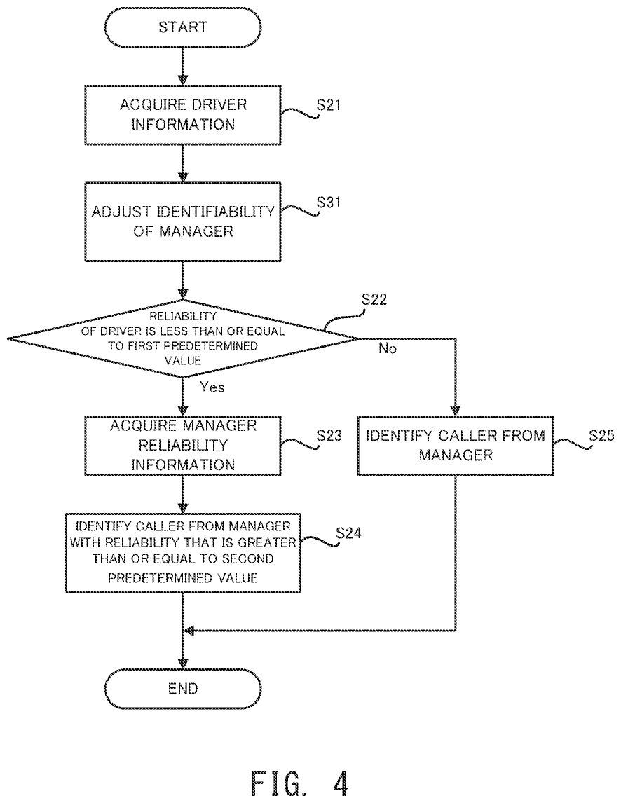

Hereinafter, with reference to FIG. 4, a flow of the caller assignment operation in the third example embodiment will be described. FIG. 4 is a flowchart illustrating the flow of the caller assignment operation in the third example embodiment. In the following description, the steps already described carry the same step numerals, and a detailed description thereof will be omitted.

As illustrated in FIG. 4, even in the third example embodiment, as in the second example embodiment, the information processing apparatus 3 performs the operations from the step S21 to the step S25. In the third example embodiment, the driver information acquired by the driver information acquisition unit 213 in the step S21 includes at least the driver reliability information and the callee history information.

In the third example embodiment, the identification unit 212 assigns the manager as the caller to the callee, on the basis of a period when the manager is not assigned to the driver as the callee. In the third example embodiment, before the determination in the step S22, the identification unit 212 adjusts identifiability of each manager, on the basis of the callee history information (step S31). For example, the identification unit 212 may change a degree of the identifiability of each manager. For example, the identification unit 212 may change the degree of the identifiability such that a manager who is frequently assigned to the execution of a roll call of a driver who wants to receive a roll call is hardly identified as a caller of the driver concerned. Furthermore, the identification unit 212 may change the degree of the identifiability such that a manager who have not performed a roll call of the driver concerned for a short time since the last call is hardly identified as the caller of the driver concerned.

In addition, the identification unit 212 may remove a manager who have not performed a roll call of the driver concerned for a time that is less than a predetermined period since the last call, may be removed from a target identified as the caller. This allows an interval of a predetermined period or longer, before a manager who is once assigned, is assigned next. It is also possible to assign a manager who is not assigned to the driver concerned, as the caller, to the driver concerned within the predetermined period.

The third example embodiment describes the reliability of the driver, the reliability of the manager, and the assignment of the manager as the caller to the driver from the callee history information, but another way of assignment may be used. For example, the identification unit 212 may refer to gender of the driver. For example, the identification unit 212 may assign a female manager to a female driver. Even in this case, the identification unit 212 may assign a highly reliable manager to a less reliable driver, and may identify the manager such that a combination of the driver and the manager is not the same as a previous combination. Furthermore, for example, the identification unit 212 may refer to a language used by the driver. For example, the identification unit 212 may assign a manager fluent in Vietnamese to a driver who uses Vietnamese. Even in this case, the identification unit 212 may assign the manager to the driver, by referring to the reliability of the driver and the manager and referring to a history of the combination.

### (3-2) Technical Effect of Information Processing Apparatus 3

In the information processing apparatus 3 according to the third example embodiment, as in the information processing apparatus 2 according to the second example embodiment, when the reliability of the driver is less than or equal to the first predetermined value, the manager with the reliability that is greater than or equal to the second predetermined value, is assigned as the caller to the driver concerned. Furthermore, the information processing apparatus 3 according to the third example embodiment assigns the manager as the caller to the driver concerned, on the basis of the period when the manager is not assigned to the driver. That is, it is possible to assign the manager as the caller, on the basis of when and from which manager the driver receives a roll call in the past. This makes it harder to make the same combination of the driver and the manager. A combination of unfamiliar individuals may result in more concentration in the execution of a roll call, which may reduce overlooking of problematic actions such as drunk driving.

Furthermore, when the same manager performs a roll call many times, the manager concerned tends to overwork, which is not preferable as a working style. In contrast, the information processing apparatus 3 according to the third example embodiment does not assign the same manager for the execution of a roll call, and thus, this situation may be avoided.

As described above, the information processing apparatus 3 according to the third example embodiment and is capable of supporting appropriate management of the execution of tasks, as in the information processing apparatus 1 according to the first example embodiment and the information processing apparatus 2 according to the second example embodiment.

### (4) Fourth Example Embodiment

Next, an information processing apparatus, a task management system, an information processing method, and a recording medium according to a fourth example embodiment will be described. The following describes the information processing apparatus, the task management system, the information processing method, and the recording medium according to the fourth example embodiment, by using an operating management system 100 to which the information processing apparatus, the task management system, the information processing method, and the recording medium according to the fourth example embodiment are applied.

### (4-1) Configuration of Operating Management System 100

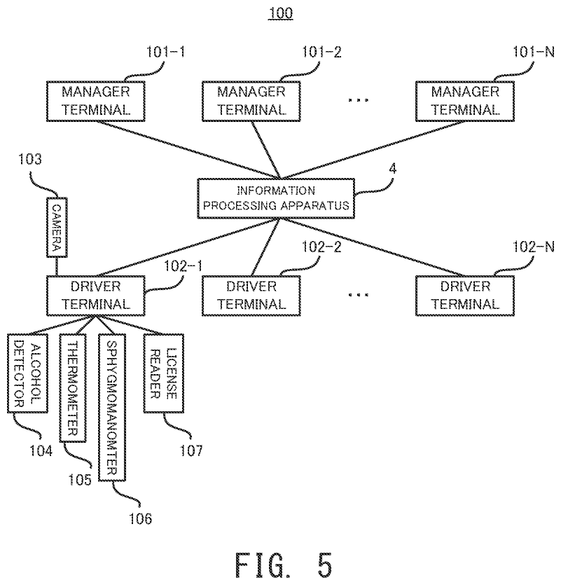

First, with reference to FIG. 5, a configuration of the operating management system 100 according to the fourth example embodiment will be described. FIG. 5 is a block diagram illustrating the configuration of the operating management system 100 according to the fourth example embodiment. As illustrated in FIG. 5, the operating management system 100 includes an information processing apparatus 4, a plurality of manager terminals 101-1, 101-2 . . . , and 101-N (simply referred to as “101” when each is not distinguished), and a plurality of driver terminals 102-1, 102-2, . . . , 102-N (simply referred to as “102” when each is not distinguished). The information processing apparatus 4 may be connected to each of the plurality of manager terminals 101 and the plurality of the driver terminals 102 through the communication apparatus 23.

Each manager terminal 101 may be used only to each manager, or may be shared by a plurality of managers. Even when the manager terminal 101 is shared by the plurality of managers, the information processing apparatus 4 is preferably configured to identify which manager uses which manager terminal 101. The information processing apparatus 4 and the manager terminal 101 may be directly connected to each other, or may be connected through a network. The manager terminals 101 may be centrally installed in the same area (building, etc.), or may be distributed and installed in different areas.

The driver terminal 102 may be a portable terminal used only to a driver, or may be a terminal apparatus provided in a garage or a business office that is shared by a plurality of the drivers. The information processing apparatus 4 and the driver terminal 102 may be connected to each other through a network.

The driver terminal 102 is wirelessly or wiredly connected to each device of a camera 103, an alcohol detector 104, a body surface thermometer 105, a sphygmomanometer 106, and a license reader 107. The camera 103 is configured to acquire a face image of the driver. The alcohol detector 104 is configured to detect expiration alcohol concentration of the driver and to obtain an alcohol concentration value (an alcohol test result). The body surface thermometer 105 is configured to acquire a body surface temperature value of the driver. The sphygmomanometer 106 is configured to acquire the blood pressure of the driver. The license reader 107 is configured to read driver's license information on the driver from a driver's license. The driver's license information may include at least an expiration date of the driver's license of the driver.

The camera 103 may be mounted on the driver terminal 102. A device that is configured to collect biometric information from the body surface thermometer 105, the sphygmomanometer 106, and the like, may be mounted on a wearable device worn by the driver. It is important to manage the health condition, and it is preferable to sequentially observe the health condition.

### (4-2) Operating Management Operation Performed by Operating Management System 100

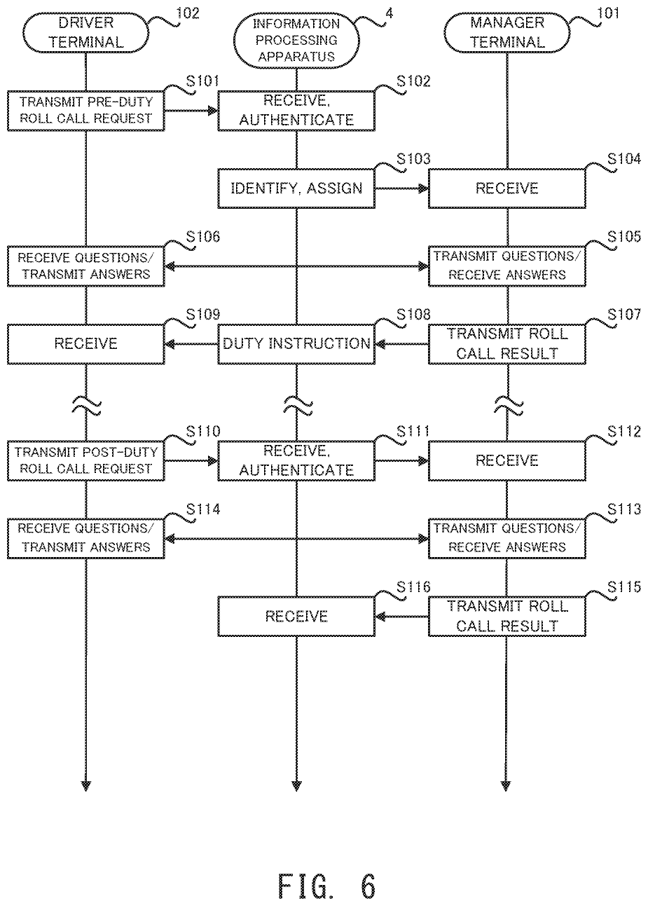

Next, with reference to FIG. 6, an operating management operation performed by the operating management system 100 according to the fourth example embodiment will be described. FIG. 6 is a diagram illustrating a flow of the operating management operation performed by the operating management system 100 according to the fourth example embodiment.

First, a driver who wishes to make a pre-duty roll call (hereinafter referred to as a “driver A”) captures a face image by the camera 103, takes an alcohol test by the alcohol detector 104, measures the body surface temperature by the surface thermometer 105, measures the blood pressure by the sphygmomanometer 106, and reads the driver's license by the license reader 107, before performing an operation of transmitting a pre-duty roll call request.

Each of the camera 103, the alcohol detector 104, the body surface thermometer 105, the sphygmomanometer 106, and the license reader 107 outputs information acquired from the driver A, to the driver terminal 102. The driver terminal 102 acquires each of the face image of the driver A from the camera 103, a result of the alcohol test of the driver A from the alcohol detector 104, a body surface temperature of the driver A from the surface thermometer 105, a blood pressure value of the driver A from the sphygmomanometer 106, and the driver's license information on the driver A from the license reader 107. In the fourth example embodiment, the camera 103 is described to, but not limited to, acquire the face image of the driver A. The camera 103 may be an infrared camera that acquires an iris image, a finger image scanner that acquires a fingerprint image and a finger vein image, a palmprint scanner that acquires a palmprint image, or the like.

In addition, the driver A may perform a roll call on his/her own (hereinafter referred to as a “self-roll call”) before the face-to-face roll call. The self-roll call may be performed by operating the driver terminal 102. The self-roll call may include at least the followings: the driver A answering check items prepared in advance by the manager or the like (where items for self-checking to be performed by the driver A, are referred to “self-check items”); and the driver A declaring his/her own condition in addition to answering the self-check items. The self-check items may include, for example, “locker storage of private smartphones and private money,” “clothing.” “wearing glasses, etc.,” “taking medicine (only if necessary),” “confirmation of belongings,” “correction of a clock,” “leaving time, out-of-service/in service, destination confirmation,” “confirmation and acceptance of notifications,” “bedtime/wake-up time registration,” and the like. The “face-to-face” state in the fourth example embodiment includes not only a face-to-face state in which the manager and the driver are close enough to keep a social distance, but also a remotely face-to-face state. The self-roll call of the driver A declaring his/her own condition, may include a self-declaration of matters to be asked by the manager in the face-to-face roll call, such as the bedtime of the day before. As described above, the self-roll call may be performed by the driver A inputting his/her answers to the driver terminal 102.

As illustrated in FIG. 6, in response to an operation by the driver A, the driver terminal 102 transmits the pre-duty roll call request to the information processing apparatus 4 (step S101). The driver terminal 102 transmits each of the face image, the alcohol test result, the body surface temperature value, the blood pressure value, the driver's license information, and a check result of the self-check of the driver, to the information processing apparatus 4, at the transmission of the pre-duty roll call request. The information processing apparatus 4 receives each of the face image, the alcohol test result, the body surface temperature value, the blood pressure value, the driver's license information, and the check result of the self-check items, as well as the pre-duty roll call request, and authenticates the driver A (step S102).

By linking the roll call request and the transmission of the alcohol test result by the alcohol detector, it is possible to prevent leakage of the alcohol test. This may not only prevent the driver's drunk driving, but also prevent the duties without taking any alcohol test. Regardless of whether or not the driver is authenticated, in a case where the expiration alcohol concentration of the driver A is greater than or equal to a threshold and the driver A is determined to be drunk, the driver A is not permitted to perform scheduled duties. Even in the case where the driver A is not permitted to perform the duties, it is advisable that the driver A is strictly warned by the appropriate manager, regarding the circumstances where the driver A is not permitted to perform the duties.

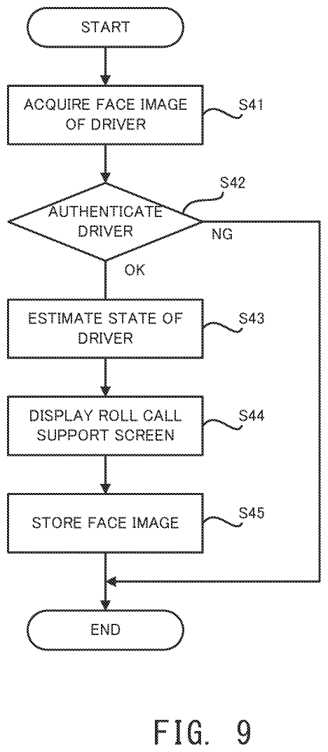

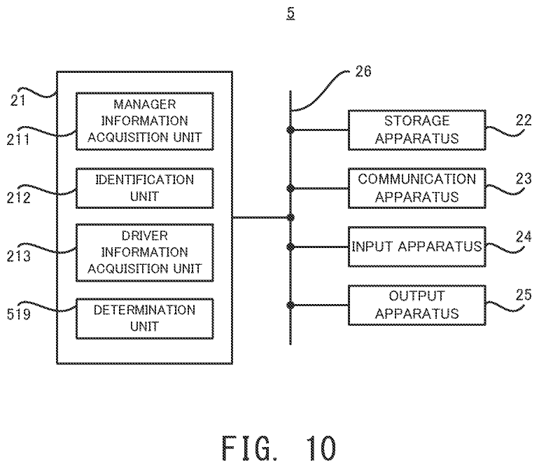

After authenticating the driver A, the information processing apparatus 4 identifies a manager as the caller (hereinafter referred to as a “manager B”), assigns the manager B to the driver A who transmits the pre-duty roll call request, and transmits the request for the manager B, to the manager apparatus 101 (steps S103). For example, when the surface temperature value or the blood pressure value of the driver A is greater than a predetermined value or in similar cases, the identification unit 212 may identify a manager familiar with a physical condition, as a caller of the driver A. The details of each of the step S102 and the step S103 in the information processing apparatus 4 will be described later in detail with reference to FIG. 9. The manager terminal 101 operated by the manager B receives the fact that the manager B is assigned to the driver A, and displays information required for the roll call (step S104).

In addition, when the information processing apparatus 4 identifies the manager as the caller, the driver terminal 102 may present, to the driver, information on the caller, such as the fact that the caller is the manager who belongs to a right/proper organization, and the name, affiliation, and manager reliability of the caller.

In response to an operation by the manager B, the manager terminal 101 transmits items to be checked by the caller for the driver in the face-to-face roll call (hereinafter referred to as “face-to-face roll call check items”) to the driver terminal 102 through the information processing apparatus 4 (step S105-1). The face-to-face roll call check items may be, for example, voice data on speaking by the manager, and may be voice data on the face-to-face roll call check items read by the manager, for example. The driver terminal 102 receives the face-to-face roll call check items transmitted by the manager terminal 101 (step S106-1). Then, in response to oral answers of the driver, the driver terminal 102 transmits, for example, voice data on the oral answers to the face-to-face roll call check items by the driver A, to the manager terminal 101 through the information processing apparatus 4, as the answers to the face-to-face roll call check items by the driver A (step S106-2). The manager terminal 101 receives the answers transmitted by the driver terminal 102 (step S105-2). The manager can check the content of the answers received by the manager terminal 101, for example, by listening to the oral answers of the driver A, for example. The manager may listen to the oral answers of the driver A, and may enter or type the content of the answers of the driver A, to the manager terminal 101. Thus, the face-to-face roll call may be performed by the manager entering the answers to the manager terminal 101. The face-to-face roll call check items and the answers thereto transmitted and received in the step S105 and the step S106, may be voice data or data for display.

In response to an operation by the manager B, the manager terminal 101 transmits a roll call result to the information processing apparatus 4 (step S107). The information processing apparatus 4 receives the roll call result, and transmits a duty instruction to the driver terminal 102 when the roll call result indicates permission for duties (step S108). The driver terminal 102 receives the duty instruction (step S109) and the driver A starts the duties.

When the driver A finishes the duties, in response to an operation by the driver A, the driver terminal 102 transmits a post-duty roll call request to the information processing apparatus 4 (step S110). Before transmitting the post-duty roll call request, the driver A captures the face image by using the camera 103, takes the alcohol test by using the alcohol detector 104, enters a working record, and the like. The driver terminal 102 transmits each of the face image, the alcohol test result, the working record, and the like, to the information processing apparatus 4 at the time of transmission of the post-duty roll call request. The information processing apparatus 4 receives each of the face image, the alcohol test result, the working record, and the like, together with the post-duty roll call request, and authenticates the driver A (step S111).

After authenticating the driver A, the information processing apparatus 4 transmits the post-duty roll call request for the corresponding manager as the caller of the driver A, to the manager terminal 101 (step S111). In the post-duty roll call, the manager receives a report about a vehicle to use, a road, an operation status, and, if another driver substitutes for the driver, a notification to the substitute driver, and confirms the presence or absence of an influence of alcohol. Here, a caller assigned after the duties is likely to be the same person as a caller before the duties. The caller after the duties may be different from the caller before the duties. In this instance, before the post-duty roll call is performed, the information processing apparatus 4 may identify the caller after the duties by performing the step S103. The manager terminal 101 receives the post-roll call request for the manager (step S112).

In response to an operation by the manager, the manager terminal 101 transmits the face-to-face toll call check items to the driver terminal 102 through the information processing apparatus 4 (step S113-1). The driver terminal 102 receives the face-to-face roll call check items transmitted by the manager terminal 101, and in response to an operation by the driver A, the driver terminal 102 transmits the answers to the face-to-face roll call check items by the driver A, to the manager terminal 101 through the information processing apparatus 4 (step S114). The manager terminal 101 receives the answers transmitted by the driver terminal 102 (step S113-2). In the post-duty roll call, belongings of the driver A may be collected, and attendance management may also be performed.

The manager terminal 101 transmits a roll call result to the information processing apparatus 4 (step S115). The information processing apparatus 4 receives the roll call result (step S116). In a case where it is confirmed in the post-duty roll call that there was a problem in the duties, the storage apparatus 22 of the information processing apparatus 4 stores it as an on-duty problem history: The on-duty problem history is included and stored in the driver information.

The arrangement of the managers to respective business office causes variations in the amount of work between the managers, depending on the size of the business office, or the like. Therefore, it is desirable that the managers are centralized in one place, and the operation of different business offices is remotely managed/controlled in one place. This prevents overwork of the manager, or the like, so that it is possible to realize appropriate operating management in a good working environment.

### (4-3) Configuration of Information Processing Apparatus 4

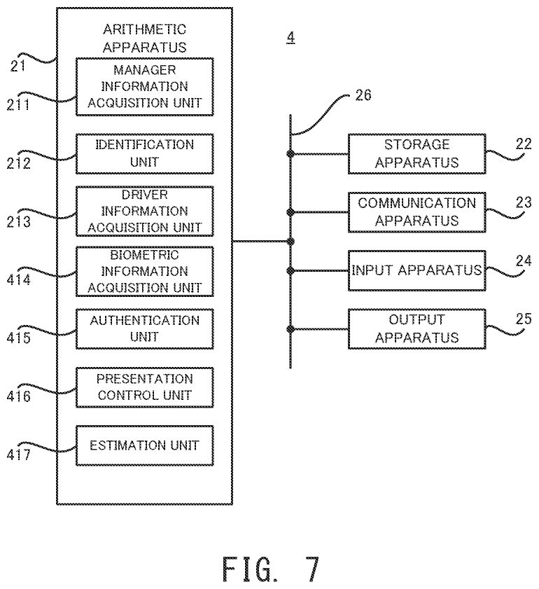

Hereinafter, with reference to FIG. 7, a configuration of the information processing apparatus 4 according to the fourth example embodiment will be described. FIG. 7 is a block diagram illustrating the configuration of the information processing apparatus 4 according to the fourth example embodiment. In the following description, the components already described carry the same reference numerals, and a detailed description thereof will be omitted.

As illustrated in FIG. 7, the information processing apparatus 4 according to the fourth example embodiment is different from the information processing apparatus 2 according to the second example embodiment (or the information processing apparatus 3 according to the third example embodiment) in that the arithmetic apparatus 21 includes a biometric information acquisition unit 414, an authentication unit 415, a presentation control unit 416, and an authentication unit 417, and in that the storage apparatus 22 stores a previous/past face image of the driver in association with to the driver as the callee. Other features of the information processing apparatus 4 may be the same as those of the information processing apparatus 2 (or the information processing apparatus 3). The face image stored in the storage apparatus 22 is associated with the driver.

The biometric information acquisition unit 414 acquires biometric information on the driver as the callee. The biometric information acquisition unit 414 may acquire at least a current face image of the driver acquired by the camera 103, the surface temperature value of the driver acquired by the body surface thermometer 105, and the blood pressure value of the driver acquired by the sphygmomanometer 106.

The authentication unit 415 acquires the current face image of the drier as the callee, and authenticates the driver on the basis of the acquired current face image of the driver. Biometric authentication includes face authentication, iris authentication, fingerprint authentication, finger vein authentication, voice authentication, ear acoustic authentication, and the like. In the fourth example embodiment, the face authentication using the face image will be described.

The biometric authentication of the driver may prevent spoofing/impersonation of the driver in the roll call. In addition, since there is also a possibility of spoofing of the manager, the authentication unit 415 may perform the biometric authentication on the manager before the roll call.

In a case where the iris authentication using an iris image is employed as the biometric authentication, the driver terminal 102 may be connectable to an infrared camera. In such a case, the biometric information acquisition unit 414 may acquire the iris image acquired by the infrared camera. In addition, in a case where the fingerprint authentication the finger vein authentication respectively using a fingerprint image and a finger vein image are used as the biometric authentication, the driver terminal 102 or driver may be connectable to a finger image scanner. In this situation, the biometric information acquisition unit 414 may acquire the fingerprint image and the finger vein image acquired by the finger image scanner. Furthermore, in a case where palmprint authentication using a palmprint image is employed as the biometric authentication, the driver terminal 102 may be connectable to a palmprint scanner. In this instance, the biometric information acquisition unit 414 may acquire the palmprint image acquired by the palmprint scanner. In addition, in a case where voice print authentication using voice data is employed as the biometric authentication, the driver terminal 102 may be connectable to a microphone. In this instance, the biometric information acquisition unit 414 may acquire the voice data acquired by the microphone. Furthermore, in a case where the ear acoustic authentication using acoustic data is employed as the biometric authentication, the driver terminal 102 may be connectable to an earphone-type microphone. In this instance, the biometric information acquisition unit 414 may acquire the acoustic data acquired by the earphone-type microphone. In addition, a multimodal authentication method that combines the biometric authentications (modals) described above may be used as thee biometric authentication. The multimodal authentication method may employ various combinations, such as a combination of the face authentication and the iris authentication, the fingerprint/vein authentication, and the palmprint authentication. The information processing apparatus 4 may be equipped with necessary equipment in accordance with the employed biometric authentication. Furthermore, the information processing apparatus 4 may perform not the biometric authentication, but authentication using information that is readable from an authentication password and a driver's license.

The estimation unit 417 estimates a state of the driver as the callee on the basis of the biometric information. The presentation control unit 416 acquires, from the storage apparatus 22, the previous face image of the driver authenticated by the authentication unit 415, and presents an image based on the current face image of the driver and the previous face image of the driver.

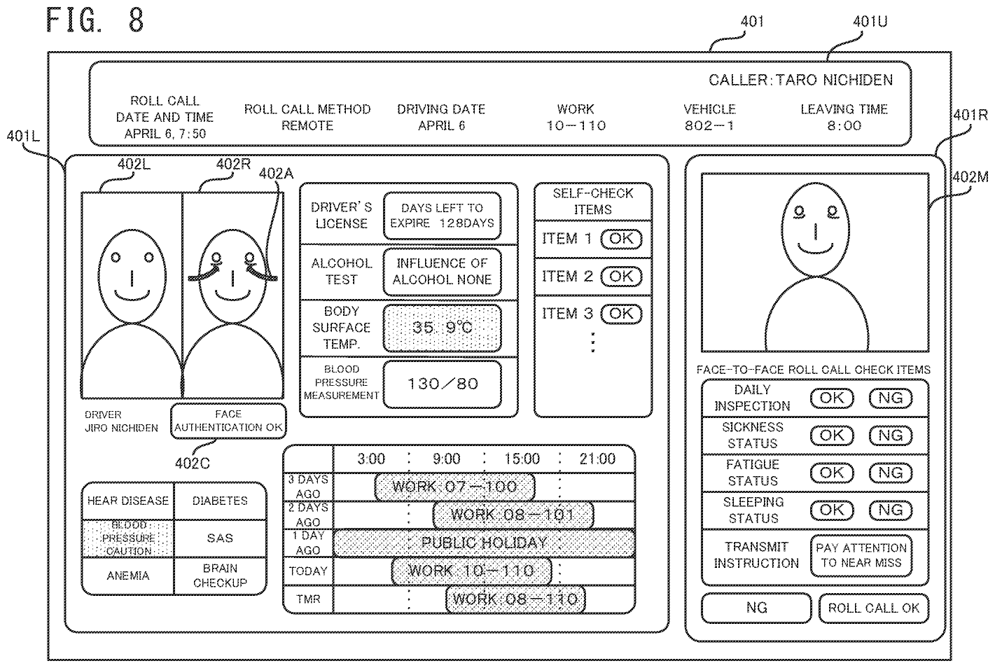

The presentation control unit 416 presents the state estimated by the estimation unit 417 to the manager B. The image based on the current face image of the driver and the previous face image of the driver, and the details of the state estimated by the estimation unit 417 will be described in detail later, with reference to FIG. 8.

### (4-4) Roll Call Support Screen 401 Displayed by Information Processing Apparatus 4

The presentation control unit 416 displays a screen for the manager B on a display of the manager terminal 101 operated by the manager B who performs a roll call. FIG. 8 illustrates a roll call support screen 401 that is the screen for the manager B. With reference to FIG. 8, the details of display control for the display of the manager terminal 101 by the presentation control unit 416 and the details of the content of the roll call in the step S105 and the step S106 will be described.

The presentation control unit 416 may display, on an upper part 401U of the roll call support screen 401, the name of the manager B, a roll call date and time of performing a roll call of the driver A (at 7:50 on April 6 in the example illustrated in FIG. 8), a roll call method of the driver A (the remote roll call in the example illustrated in FIG. 8), a driving date of the driver A (on April 6 in the example illustrated in FIG. 8), a work number of a duty of the driver A (10-110 in the example illustrated in FIG. 8), a vehicle number of the driver A (802-1 in the example illustrated in FIG. 8), and a leaving time of the driver A (at 8:00 in the example illustrated in FIG. 8).

The presentation control unit 416 may display a driver information display part 401L including information or the like about the driver A transmitted by the driver terminal 102 in the step S101, on a left side of the roll call support screen 401. The presentation control unit 416 may display a roll call matter display part 401R including the face-to-face roll call check items or the like, on a right side of the roll call support screen 401.

The presentation control unit 416 may display a current face image 402R and a previous face image 402L of the drier A side by side, in an upper left area of the driver information display part 401L. In addition, it is seen that there are dark circles under the eyes when the current face image is compared with the previous face image. Thus, the display control unit 416 may superimpose an arrow mark 402A on the corresponding part so as to make the dark circles noticeable. The presentation control unit 416 may analyze the state of the driver, such as looking paler and blushing more than usual, from the face image of the driver, and may allow the state of the driver to be displayed on the display of the manager terminal 101. This may make it easier for the manager B to understand a difference between a usual face with no problem and a current face. In particular, the dark circles under the eyes, the pale complexion, and the blushing, may be a clue to know a physical disorder, and are thus important as information to bring attention to the manager B.

The presentation control unit 416 may use and display a face image acquired in the latest roll call, as the previous face image, but may use and display a face image acquired in a similar environment in a case where an environment in the latest roll call is different from a current environment. The environment may include factors that affect the surrounding brightness of an imaging target, such as a location at the time of imaging in a garage, a business office, or the like, a state of the weather at the time of imaging, a lighting state at the time of imaging, and a time zone of imaging. The surrounding brightness of the imaging target may be the brightness of a background of a target within an angle of view of the camera 103. The presentation control unit 416 may determine in which environment a current or past roll call is, from the brightness of a background of the face image. Alternatively, the presentation control unit 416 may determine the environment from the brightness of a face of the driver in the image. The presentation control unit 416 may use and display the newest face image from among face images captured when the environment is similar to the current environment.

Alternatively; the presentation control unit 416 may correct the brightness of face images in view of the environment at the time of imaging the face images, and may display the face images corrected to have the same brightness side by side. Such a technique/technology that makes it easy to understand the difference between the usual face with no problem and the current face, is useful not only for the remote roll call, but also for the face-to-face roll call. This technique/technology may help the manager as the caller to know the state of the driver in a short time. In addition, even when the driver performs the self-roll call, the technique/technology may help the driver to objectively understand his/her current state.

The current face image 402R displayed on the driver information display part 401L may be the face image used in the authentication in the step S102. In this case, the presentation control unit 416 may also display characters of “face authentication OK” 402C indicating that the authentication is completed, on a lower side of the current face image.

The presentation control unit 416 may display the information detected from the current driver A in an upper middle area of the driver information display part 401L. In the example illustrated in FIG. 8, the driver's license of the driver A indicates that the expiration date is in 128 days, that no influence of alcohol is detected in the alcohol test, that the body surface temperature is 35.9° C., and that a blood pressure measurement result is 130 over 80.

For example, in a case where the storage apparatus 22 stores an average body surface temperature value of the driver concerned and the current body surface temperature value is significantly different from the average body surface temperature value, the estimation unit 417 may estimate that the driver should be careful, and the presentation control unit 416 may highlight an area of “body surface temperature” in red or the like. The presentation control unit 416 may also display the body surface temperature in a previous roll call.

Furthermore, the presentation control unit 416 may display the result of the self-check of the driver A in an upper right area of the driver information display part 401L. In the example illustrated in FIG. 8, the check result of the driver A for each item is “OK.”

The presentation control unit 416 may display information of which the manager B is to be notified, in a lower left area of the driver information display part 401L. In the example illustrated in FIG. 8, the following items are listed as examples: “heart disease,” “diabetes,” “blood pressure,” “SAS (sleep apnea syndrome),” “anemia,” and “brain checkup”, and an area of “blood pressure” is highlighted.

For example, in a case where the storage apparatus 22 stores the average blood pressure value of the driver concerned and a current blood pressure value is significantly different from the average blood pressure value, the estimation unit 417 may estimate that the driver should be careful, and the presentation control unit 416 may highlight the area of “blood pressure” in red or the like. The presentation control unit 416 may also display the blood pressure in the previous roll call.

The presentation control unit 416 may display a working status of the driver A from the near past to the near future, in a lower right area of the driver information display part 401L. In the example illustrated in FIG. 8, the work number of the duty of the driver A is 07-100 three days ago, 08-101 two days ago, a public holiday one day ago, 10-110 today; and 11-108 tomorrow:

The presentation control unit 416 may display a current video 402M of the driver A in an upper area of the roll call matter display part 401R. That is, the communication between the manager terminal 101 and the driver terminal 102 may be performed by using a videoconference system, and the manager B and the driver A may call or be called while confirming the current video and voice with each other. The manager B can confirm a situation of the driver A who answers the check items in the roll call. In addition, the manager B can observe the face of the driver A and check an insufficient sleep or poor physical health from the color of the face or the like. This video 402M may be storable. In addition, the manager may flag the video of the driver who is judged to be in a bad physical condition as a result of performing a roll call, and the flagged video of the driver may be stored longer than other videos. For example, an unflagged normal video may be stored for a year and the flagged video may be stored for three years.

The presentation control unit 416 may display the face-to-face roll call check items in a middle area of the roll call matter display part 401R. In the example illustrated in FIG. 8, the manager B asks the driver A about each item of “daily inspection”, “sickness status”, “fatigue status”, and “sleeping status (6 hours and 40 minutes)”, and can input a determination result for each item (pushing an “OK” button or an “NG” button). The manager B can confirm the condition of a vehicle for business use, as “daily inspection.” The presentation control unit 416 may display a sleeping time of the driver, on the basis of the bedtime and the wake-up time registered in the self-check by the driver.

In addition, the manager B may give an instruction necessary for ensuring safety. In the example illustrated in FIG. 8, since it is the first work of the driver A after a public holiday; the presentation control unit 416 may encourage the manager B to give and transmit an instruction of “paying attention to a near miss after the holiday”. In addition, for example, when the driver is working differently from usual, the presentation control unit 416 may encourage the manager to give and transmit an instruction of “recalling a rest”.

The presentation control unit 416 may display an area in which the roll call result is inputted, in a lower area of the roll call matter display part 401R. In the example illustrated in FIG. 8, a “roll call OK” button and an “NG” button are displayed, and the manager B can press one of the buttons on the basis of the roll call result.

### (4-5) Roll Call Support Operation Performed by Information Processing Apparatus 4

Hereinafter, with reference to FIG. 9, a flow of a roll call support operation in the fourth example embodiment will be described. FIG. 9 is a flowchart illustrating the flow of the roll call support operation in the fourth example embodiment.

As illustrated in FIG. 9, the biometric information acquisition unit 414 acquires the current face image of the driver received in the step S102 illustrated in FIG. 6 (step S41). Then, the authentication unit 415 authenticates the driver on the basis of the current face image acquired by the biometric information acquisition unit 414 in the step S41 (step S42).

In the step S42, when the driver is authenticated (the step S42: OK), the estimation unit 417 estimates the state of the driver on the basis of the biometric information acquired by the biometric information acquisition unit 414 (step S43).

The presentation control unit 416 displays the roll call support screen 401 (step S44). The storage apparatus 22 further stores the current face image of the authenticated driver in association with the driver (step S45).

When the driver is not authenticated in the step S42 (the step S42: NG), the communication apparatus 23 notifies both the manager terminal 101 and the driver terminal 102 that the authentication is failed.

In the fourth example embodiment, the presentation control unit 416 presents, to the manager, matters to be presented to the manager, through the display of the manager terminal 101, but may present the matters to the manager by audio/voice through a speaker.

### (4-6) Technical Effect of Information Processing Apparatus 4

Since the information processing apparatus 4 according to the fourth example embodiment authenticates the driver on the basis of the current face image of the driver as the callee, the reliability becomes higher than that in face-to-face authentication by the caller. Furthermore, since the information processing apparatus 4 according to the fourth example embodiment displays the current face image and the previous face image of the authenticated driver side by side, it is possible to visually present, to the caller, a difference in the face between in the past and at present. By confirming the current face image and the previous image displayed side by side, the caller can easily judge poor physical health or similar conditions of the driver in a short time.

Furthermore, the information processing apparatus 4 according to the fourth example embodiment acquires the biometric information on the driver as the callee, estimates the state of the driver on the basis of the biometric information, and presents the estimated state to the caller. By presenting the estimated state of the driver to the caller as reference information, the caller can judge the state of the driver more easily in a short time. Therefore, the information processing apparatus 4 according to the fourth example embodiment is capable of supporting the realization of execution of an appropriate roll call, and is capable of supporting the appropriate management of execution of tasks.

### (5) Fifth Example Embodiment

Next, an information processing apparatus, a task management system, an information processing method, and a recording medium according to a fifth example embodiment will be described. The following describes the information processing apparatus, the task management system, the information processing method, and the recording medium according to the fifth example embodiment, by using an operating management system 500 and an information processing apparatus 5 to which the information processing apparatus, the task management system, the information processing method, and the recording medium according to the fourth example embodiment are applied.

### (5-1) Configuration of Information Processing Apparatus 5

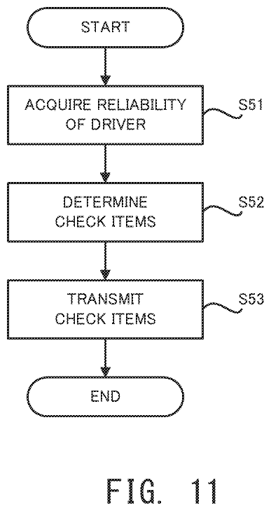

Hereinafter, with reference to FIG. 10, a configuration of the information processing apparatus 5 according to the fifth example embodiment will be described. FIG. 10 is a block diagram illustrating the configuration of the information processing apparatus 5 according to the fifth example embodiment. In the following description, the components already described carry the same reference numerals, and a detailed description thereof will be omitted.

As illustrated in FIG. 10, the information processing apparatus 5 according to the fifth example embodiment is different from the information processing apparatus 2 according to the second example embodiment (or the information processing apparatus 3 according to the third example embodiment) in that the arithmetic apparatus 21 includes a determination unit 519. Other features of the information processing apparatus 5 may be the same as those of the information processing apparatus 2 (or the information processing apparatus 3).

### (5-2) Roll Call Support Operation Performed by Information Processing Apparatus 5

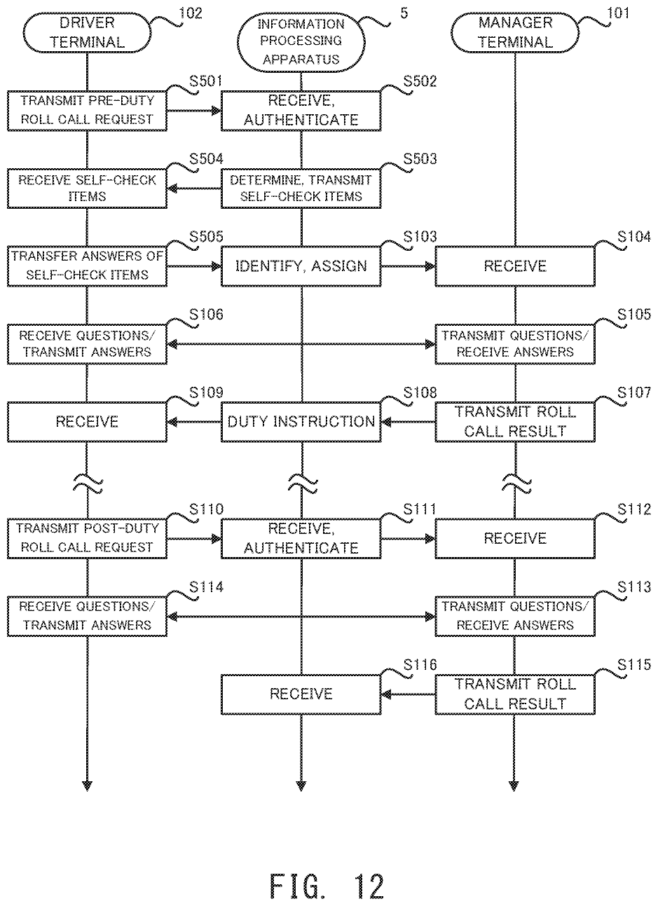

Hereinafter, with reference to FIG. 11, a flow of the roll call support operation in the fifth example embodiment will be described. FIG. 11 is a flowchart illustrating the flow of the roll call support operation in the fifth example embodiment.

As illustrated in FIG. 11, the driver information acquisition unit 213 acquires the driver information on the driver concerned (step S51). This step S51 may be the same as the step S21 in FIG. 3. The determination unit 519 determines matters to be confirmed with the driver in the roll call, in accordance with the reliability of the driver as the callee (step S52).

Here, there are at least two types of items to be confirmed with the driver before duties, i.e., the self-check items and the face-to-face roll call check items. Since the roll call to be performed varies depending on the reliability of the driver, the determination unit 519 may determine at least one of the self-check items and the face-to-face roll call check items in accordance with the reliability of the driver.

For example, in a case where the reliability of the driver is high, the determination unit 519 may change some of the face-to-face roll call check items to the self-check items. In this case, some of the face-to-face roll call check items are already checked in the face-to-face roll call. Therefore, the manager may confirm the result of the self-check performed by the driver, without checking the relevant items in the face-to-face state. In this way, it is possible to simplify a roll call for a highly reliable driver, to reduce a time required for the roll call, and to reduce a burden on both the driver and the manager.

On the other hand, in a case where the reliability of the driver is low; the determination unit 519 may increase the number of at least one of the self-check items and the face-to-face roll call check items. For example, in a case where the driver is an accident-causing person, the determination unit 519 may increase the number of both the self-check items and the roll call check items, compared with a case of an ordinary driver. The determination unit 519 may add, as check items, items that are usually not checked, for at least one of the self-check items and the face-to-face roll call check item of the driver who works in a different time zone from usual. In this way, it is possible to carefully perform a roll call of a less reliable driver.

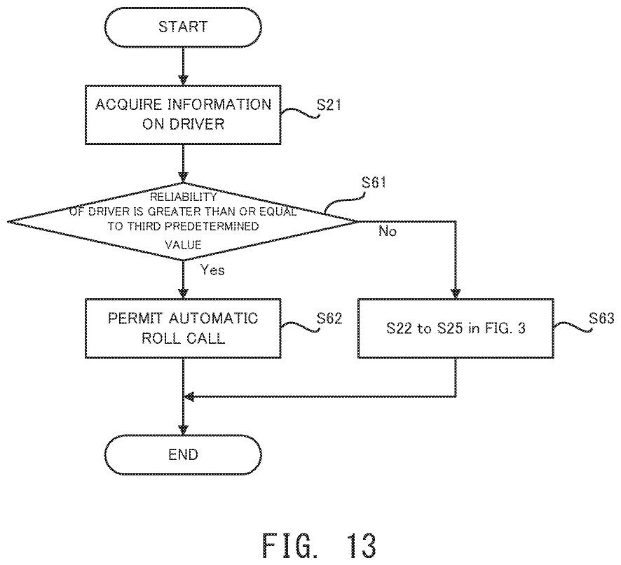

The communication apparatus 23 transmits the face-to-face roll call check items determined by the determination unit 519 to the manager terminal 101, and transmits the self-check items determined by the determination unit 519 to the driver terminal 102 (step S53, and step S503 in FIG. 12).

In addition, the determination unit 519 may determine whether or not to provide the driver with the procedure of the roll call before the roll call. The less reliable driver is not well organized in the roll call, and takes a longer time for the roll call in many cases. In contrast, if the driver knows, before the roll call, the procedure of the roll call to be received by the driver concerned, then, the roll call is expected to be completed in a short time. Therefore, the determination unit 519 may determine to provide the procedure of the roll call to the less reliable driver before the roll call.

The determination unit 519 may determine the amount of the procedure of the roll call to be provided to the manager, in accordance with the reliability of the manager. A less reliable manager is not well organized in the roll call, and takes a longer time for the roll call in many cases. In contrast, if the manager concerned is provided with in-depth matters to be checked in the roll call, before the roll call, then, the roll call is expected to be completed in a short time. For this reason, the determination unit 519 may determine to provide the less reliable manager with a manual describing in details the items to be checked in the roll call or the like, before the roll call. For example, the presentation control unit 416 may present the manual for the manager determined by the determination unit 519, to the manager through the display of the manager terminal 101. On the other hand, a highly reliable manager is organized in the roll call and can complete the roll call in a short time. For this reason, it is not necessary to provide the detailed procedure of the roll call to the manager concerned. For this reason, the determination unit 519 may determine to provide the highly reliable manager with a manual simply describing the procedure of the roll call.

Next, with reference to FIG. 12, the roll call support operation performed by the operating management system 500 including the information management apparatus 5 according to the fifth example embodiment will be described. FIG. 12 is a diagram illustrating a flow of the roll call support operation performed by the operating management system 500 according to the fifth example embodiment. In the following description, the steps already described carry the same step numerals, and a detailed description thereof will be omitted.

As illustrated in FIG. 12, in response to an operation by the driver A, the driver terminal 102 transmits the pre-duty roll call request to the information processing apparatus 5 (step S501). In the fifth example embodiment, the driver terminal 102 transmits each of the face image, the alcohol test result, the body surface temperature value, the blood pressure value, and the driver's license information, to the information processing apparatus 5, at the transmission of the pre-duty roll call request. The information processing apparatus 5 receives each of the information on the driver transmitted by the driver terminal 102, together with the pre-duty roll call request, and authenticates the driver A (step S502).

After authenticating the driver A, the information processing apparatus 5 determines the self-check items for the driver A in accordance with the reliability of the driver A, and transmits the determined self-check items for the driver A, to the driver terminal 102 (step S503, and step S53 in FIG. 11). At this time, the determination unit 519 may determine the self-check items for the driver A, after recalculating the reliability of the driver A in the roll call, with reference to the information on the driver acquired in the step S502.

The driver terminal 102 receives the self-check items for the driver A (step S504). The driver A performs the self-check by operating the driver terminal 102, and transmits the result of the self-check to the information processing apparatus 5 (step S505).

After the step S505, as illustrated in FIG. 12, even in the fifth example embodiment, as in the fourth example embodiment, the operating management system 500 performs the operations from the step S103 to the step S116.

### (5-3) Technical Effect of Information Processing Apparatus 5

The information processing apparatus 5 according to the fifth example embodiment determines the matters to be confirmed with the driver in the roll call, on the basis of the reliability of the driver as the callee. This makes it possible to simplify a roll call for a highly reliable driver, to reduce a time required for the roll call, and to reduce a burden on both the driver and the manager. On the other hand, it is possible to carefully perform a roll call of a less reliable driver. By carefully performing a roll call of the less reliable driver, it is possible to reduce the likelihood of an accident. Therefore, even the information processing apparatus 5 according to the fifth example embodiment is capable of supporting the realization of execution of an appropriate roll call, and is capable of supporting the appropriate management of execution of tasks.

### (6) Sixth Example Embodiment

Next, an information processing apparatus, an information processing method, and a recording medium according to a sixth example embodiment will be described. The following describes the information processing apparatus, the information processing method, and the recording medium according to the sixth example embodiment, by using an information processing apparatus 6 to which the information processing apparatus, the information processing method, and the recording medium according to the sixth example embodiment are applied.

### (6-1) Roll Call Support Operation Performed by Information Processing Apparatus 6

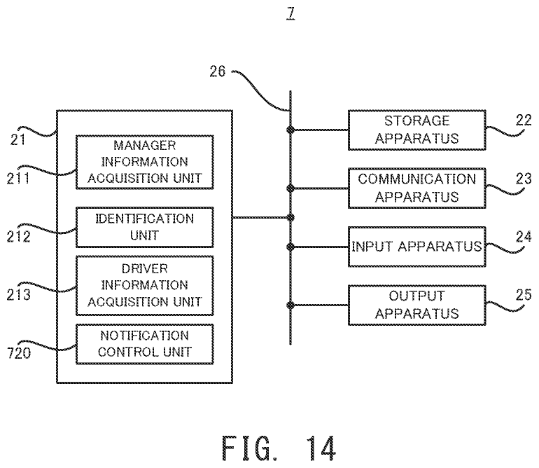

Hereinafter, with reference to FIG. 13, a flow of the roll call support operation in the sixth example embodiment will be described. FIG. 13 is a flowchart illustrating the flow of the roll call support operation in the sixth example embodiment. In the following description, the steps already described carry the same step numerals, and a detailed description thereof will be omitted.

As illustrated in FIG. 13, in the sixth example embodiment, as in the second example embodiment, the information processing apparatus 6 performs the operations from the step S21 to the step S25. The identification unit 212 determines whether or not the reliability of the driver is greater than or equal to a third predetermined value, by using the driver reliability information out of the driver information acquired in the step S21 (step S61). As a result of the determination in the step S61, when the reliability of the driver is greater than or equal to the third predetermined value (the step S61: Yes), the identification unit 212 permits a roll call that does not involve the caller (step S62).

That is, a highly reliable driver can omit human checking before duties. For example, for the highly reliable driver, the determination unit 519 may set all the check items as the self-check items, and may set the self-roll call to be performed in all the roll calls. Alternatively, the determination unit 519 may set most items as the self-check items, and may set only a minimum of the face-to-face roll call check items to be checked through interaction with a robot or the like.

At this time, the robot or the like may compare the driver's voice state, facial state, or the like with the normal states, and may determine whether to permit the driver to perform duties. In this instance, the authentication unit 415 may authenticate the driver, not by using the face image, but by voice. Alternatively: the determination unit 519 may set only a minimum of the items that allows the authentication of the driver by voice, as the face-to-face roll call check items, and may set the remaining items as the self-check items. As a result of the determination in the step S61, when the reliability of the driver is less than the third predetermined value (the step S61: No), the processing is moved to a step S63, and the step S22 to the step S25 in FIG. 3 are operated.

In addition, there may be a manager who confirms the interaction between the driver and the robot or the like. In this case, for example, a single manager can remotely and simultaneously monitor the interaction with ten robots or the like. Thus, it is possible to increase the number of the drivers who can be managed by a single manager, while preventing an increase in a burden on the manager. For example, in a case where a determination material capable of determining that the driver is not permitted to perform duties, is detected during the interaction with the robot or the like, the robot or the like may issue a warning to the manager, or may highlight a detection result on a screen for the confirmation by the manager. The determination material for determining that the driver is not permitted to perform duties, may include a pale complexion of the driver, a raspy voice of the driver, or the like.

In addition, in the roll call, the interaction between the manager and the driver may be omitted, and the manager only confirms a result of the self-roll call of the driver.

### (6-2) Technical Effect of Information Processing Apparatus 6

The information processing apparatus 6 according to the sixth example embodiment permits the driver to perform a roll call that does not involve the caller, when the reliability of the driver as the callee is greater than or equal to the third predetermined value. This may reduce a labor burden of the manager, while supporting the realization of execution of an appropriate roll call. Therefore, the information processing apparatus 6 according to the sixth example embodiment is also capable of supporting the appropriate management of execution of tasks.

### (7) Seventh Example Embodiment

Next, an information processing apparatus, an information processing method, and a recording medium according to a seventh example embodiment will be described. The following describes the information processing apparatus, the information processing method, and the recording medium according to the seventh example embodiment, by using an information processing apparatus 7 to which the information processing apparatus, the information processing method, and the recording medium according to the seventh example embodiment are applied.

### (7-1) Configuration of Information Processing Apparatus 7

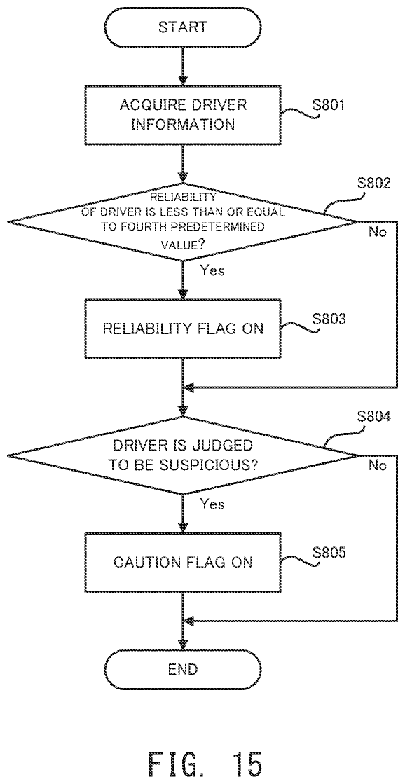

Hereinafter, with reference to FIG. 14, a configuration of the information processing apparatus 7 according to the seventh example embodiment will be described. FIG. 14 is a block diagram illustrating the configuration of the information processing apparatus 7 according to the seventh example embodiment. In the following description, the components already described carry the same reference numerals, and a detailed description thereof will be omitted.

As illustrated in FIG. 14, the information processing apparatus 7 according to the seventh example embodiment is different from the information processing apparatus 2 according to the second example embodiment (or the information processing apparatus 3 according to the third example embodiment) in that the arithmetic apparatus 21 includes a notification control unit 720. Other features of the information processing apparatus 7 may be the same as those of the information processing apparatus 2 (or the information processing apparatus 3).

For example, the driver performs daily inspection, such as checking tire air pressure, checking braking efficiency, and checking lights like blinkers, or the like, before duties. At this time, in a case where some abnormality of a vehicle is found by the driver, the driver terminal 102 may notify the information processing apparatus 7 of the abnormality of the vehicle, in response to an operation by the driver. The notification control unit 720 provided in the information processing apparatus 7 that has received the notification of the abnormality, notifies a mechanic for the vehicle scheduled to be driven by the driver that there is an abnormality in the vehicle. It is possible to solve the abnormality at an early stage, by notifying a mechanic familiar with the details of the abnormality and letting him/her handle the situation.

In addition, in a case where the information processing apparatus 7 includes the presentation control unit 416 described in the fourth example embodiment, the presentation control unit 416 provided in the information processing apparatus 7 may display a warning screen for warning of the abnormality of the vehicle, on the display of the manager terminal 101, when receiving a notification of the abnormality from the driver terminal 102. The presentation control unit 416 may display, on the warning screen, detailed information such as a vehicle inspection result of the abnormal vehicle, the content of handling by the mechanic, and information on necessity/unnecessity of a replacement vehicle. Furthermore, the presentation control unit 416 may display, on the warning screen, an area for inputting therein an instruction to change allocation of a vehicle. That is, in a case where the manager judges that it is better to change the vehicle allocation, the vehicle allocation may be changed by an operation of the manager terminal 101 by the manager. In addition, in a case where there is an abnormality in the vehicle, for example, in the case of an abnormality in a tire, the identification unit 212 may assign a manager familiar with a tire, as the caller of a driver who drives the vehicle.

### (7-2) Technical Effect of Information Processing Apparatus 7

In a case where there is an abnormality in the vehicle scheduled to be driven by the driver, the information processing apparatus 7 according to the seventh example embodiment notifies the mechanic for the corresponding vehicle of the abnormality. Thus, the information processing apparatus 7 according to the seventh example embodiment is also capable of supporting the appropriate management of execution of tasks.

### (8) Eighth Example Embodiment

Next, an information processing apparatus, a task management system, an information processing method, and a recording medium according to an eighth example embodiment will be described. The following describes the information processing apparatus, the task management system, the information processing method, and the recording medium according to the eighth example embodiment, by using an operating management system 800 and an information processing apparatus 8 to which the information processing apparatus, the task management system, the information processing method, and the recording medium according to the fourth example embodiment are applied.

### (8-1) Pre-Duty Operating Management Operation Performed by Information Processing Apparatus 8

The information processing apparatus 8 according to the eighth example embodiment may have the same configuration as that of at least one of the information processing apparatus 2 according to the second example embodiment to the information processing apparatus 7 according to the seventh example embodiment. Especially in the eighth example embodiment, the storage apparatus 22 stores an operating vehicle list. The operating vehicle list stores at least information about vehicles in operation and vehicles scheduled to be operated today. The information about the vehicle may include at least information about a vehicle number, a route number, a destination, a reliability flag of a driver scheduled to drive a vehicle (hereinafter referred to as a “reliability flag”), and a caution flag of a driver scheduled to drive a vehicle (hereinafter referred to as a “caution flag”). The reliability flag is turned on when the reliability of the driver is less than or equal to a fourth predetermined value. The caution flag is turned on when the manager makes a judgment of the “roll call OK” and judges that the driver concerned is a suspicious person, due to poor physical health or the like.

For example, the caution flag may be a flag to be added to a driver who is a little questionable, but not enough to make a judgement of the “roll call NG.” For example, the flag may be added in a case where the driver cannot speak properly, or in a case where the tempo of a response from the driver does not match up, or in similar cases, even though there is no problem in the driver's answers or the driver's alcoholic test.

In a case where the manager judges that the driver is a suspicious person, the manager terminal 101 may transmit information indicating that the driver is a suspicious person, to the information processing apparatus 8, in response to an operation by the manager. The storage apparatus 22 may include and store driver caution information indicating the suspicious person, in the driver information on the driver concerned.

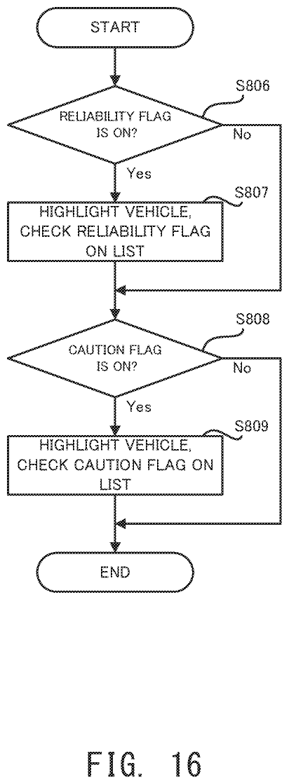

Hereinafter, with reference to FIG. 15, a pre-duty operating management operation performed by the information processing apparatus 8 according to the eighth example embodiment will be described. FIG. 15 is a diagram illustrating a flow of the pre-duty operating management operation performed by the information processing apparatus according to the eighth example embodiment.

As illustrated in FIG. 15, the driver information acquisition unit 213 acquires the driver information (step S801). The driver information includes at least the driver reliability information and the driver caution information. The identification unit 212 determines whether or not the reliability of the driver is less than or equal to the fourth predetermined value, by using the driver reliability information out of the driver information acquired in the step S801 (step S802). As a result of the determination in the step S802, when the reliability of the driver is less than or equal to the fourth predetermined value (the step S802: Yes), the reliability flag corresponding to the vehicle scheduled to be driven by the driver concerned on the operating vehicle list in the storage apparatus 22 is changed to be on. The processing is moved to a step S804, regardless of the result of the determination in the step S802.

The identification unit 212 determines whether or not the driver is a suspicious person, by using the driver caution information out of the driver information acquired in the step S801 (step S804). As a result of the determination in the step S804, when the driver is a suspicious person (the step S804: Yes), the caution flag corresponding to the vehicle scheduled to be driven by the driver concerned on the operating vehicle list in the storage apparatus 22 is changed to be on (step S805).

### (8-2) On-Duty Operating Management Operations Performed by Operating Management System 800

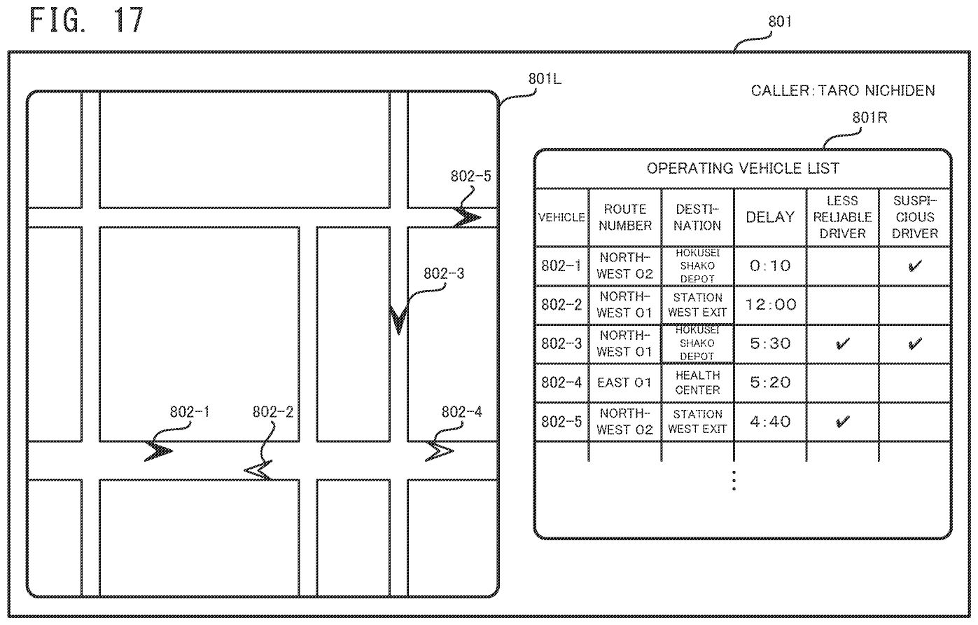

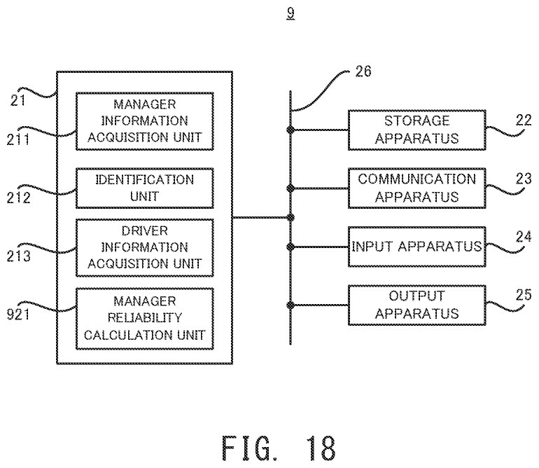

Next, with reference to FIG. 16 and FIG. 17, an on-duty operating management operation performed by the operating management system 800 including the information processing apparatus 8 according to the eighth example embodiment will be described. FIG. 16 is a diagram illustrating a flow of the on-duty operating management operation performed by the operating management system 800 according to the eighth example embodiment. A configuration of the operating management system 800 may be the same as that of the operating management system 100. Furthermore, FIG. 17 illustrates an example in which a monitoring screen 801 for monitoring by the manager is displayed on the display of the manager terminal 101. The eighth example embodiment describes the example in which the monitoring screen 801 is displayed on the display of the manager terminal 101, but the monitoring screen 801 may be displayed on a display other than the display of the manager terminal 101. For example, the monitoring screen 801 may be displayed on a display of the driver terminal browsed by the driver, or may be displayed on a display browsed by those who are not involved in duties, such as a passenger of a bus or the like.

As illustrated in FIG. 17, the presentation control unit 416 may display a map 801L of an operating management area in a left part of the monitoring screen 801, and may display an operating vehicle list 801R of vehicles currently operated in the relevant area in a right part. The operating management area may include, at least, an area where a vehicle driven by the driver on whom the manager performs a pre-duty roll call, is operated. The presentation control unit 416 may display, on the map 801L, currently operated vehicles 802-1, 802-2, 802-3, 802-4, and 802-5 (simply referred to as “802” when each is not distinguished). Alternatively, the presentation control unit 416 may display the vehicle driven by the driver on whom the manager performs a pre-duty roll call.

As illustrated in FIG. 16, the presentation control unit 416 determines whether or not the reliability flag of the vehicle is on, with reference to the operating vehicle list in the storage apparatus 22 (step S806). As a result of the determination in the step S806, when the reliability flag is on (the step S806: Yes), the presentation control unit 416 highlights a corresponding vehicle 802 on the map 801L, and checks a less reliable driver column in the operating vehicle list 801R (step S807). In FIG. 17, the vehicles 802-3 and 802-5 are highlighted, and the less reliable driver column for them is checked. The processing is moved to a step S808, regardless of the determination in the step S806.

The presentation control unit 416 determines whether or not the caution flag of the vehicle is on, with reference to the operating vehicle list in the storage apparatus 22 (step S808). As a result of the determination in the step S808, when the caution flag is on (the step S808: Yes), the presentation control unit 416 highlights the corresponding vehicle 802 in the map 801L, and checks a suspicious driver column in the operating vehicle list 801R (step S909). In FIG. 17, the vehicles 802-1 and 802-3 are highlighted, and the suspicious driver column for them is checked. This makes it easier for the manager to notice a vehicle to be paid more attention than the others. In addition, basically, the same manager is in charge of the pre-duty roll call and the monitoring of an on-duty vehicle, but even when a different manager is in charge, the manager who takes over may easily focus on the vehicle to be paid attention, because the vehicle to be paid attention is highlighted.

Furthermore, the manager who monitors the on-duty vehicle may preferably understand a vehicle state. The presentation control unit 416 may display, on the monitoring screen 801, information on the vehicle state such as tire air pressure, gasoline shortage, and a stepping condition of a brake, together. In addition, in a case where the vehicle is a passenger vehicle, when a passenger evaluates the driver by using an application or the like of a smartphone, the manager may be notified of information on the evaluation through the monitoring screen 801. Furthermore, the reliability of the driver may be increased or reduced, on the basis of the evaluation by the passenger. As a result, it is possible to prevent the occurrence of a situation that would interfere with the operation of the vehicle, regardless of whether a problem is caused by the driver or by the vehicle. Alternatively, it is possible to immediately deal with even the situation that would interfere with the operation.

In many cases, the less reliable driver is judged to be a suspicious person. Therefore, the less reliable driver column and the suspicious driver column of the operating vehicle list 801R may be integrated and checked in a case where the driver corresponds to at least one of being less reliable and being suspicious.

### (8-3) Technical Effect of Information Processing Apparatus 8

The information processing apparatus 8 according to the eighth example embodiment displays a route map of the vehicle driven by the driver, and highlights at least one of the vehicle driven by the driver who is judged by the manager to be a suspicious person and the vehicle driven by the less reliable driver. Thus, the manager may more easily notice the vehicle to be paid more attention than the others. Therefore, the information processing apparatus 8 according to the eighth example embodiment is also capable of supporting the appropriate management of execution of tasks.

### (9) Ninth Example Embodiment

Next, an information processing apparatus, an information processing method, and a recording medium according to a ninth example embodiment will be described. The following describes the information processing apparatus, the information processing method, and the recording medium according to the ninth example embodiment, by using an information processing apparatus 9 to which the information processing apparatus, the information processing method, and the recording medium according to the ninth example embodiment are applied.

The judgment by the manager that the driver is a suspicious person may influence a degree of reliability of the manager. That is, in a case where the driver who is judged by the manger to be a suspicious person, causes trouble on duty; the reliability of the manager who performs a roll call of the driver concerned may be calculated to be high. In other words, the manager who is capable of noticing that the driver is a suspicious person who may cause trouble on duty, may be highly evaluated. On the other hand, in a case where the driver who is judged by the manager to be a suspicious person, does not particularly cause trouble on duty; the reliability of the manager who performs a roll call of the driver concerned may be calculated to be low: In addition, in a case where the driver who is permitted to perform duties, causes a serious problem such as dozing, the reliability of the manager who has permitted the driver concerned to perform duties, may be calculated to low. For example, in calculating the reliability of the manager, a ratio of increasing or reducing the reliability of the manager may be changed in accordance with a degree of importance of an accident or a violation caused by the driver. In addition, in a case where the manager adds the flag to a particular driver many times and the driver does not particularly cause trouble, the manager and the driver may be regarded as a not good combination and as not providing an appropriate roll call, and the manager concerned and the driver concerned may not be combined.

### (9-1) Configuration of Information Processing Apparatus 9

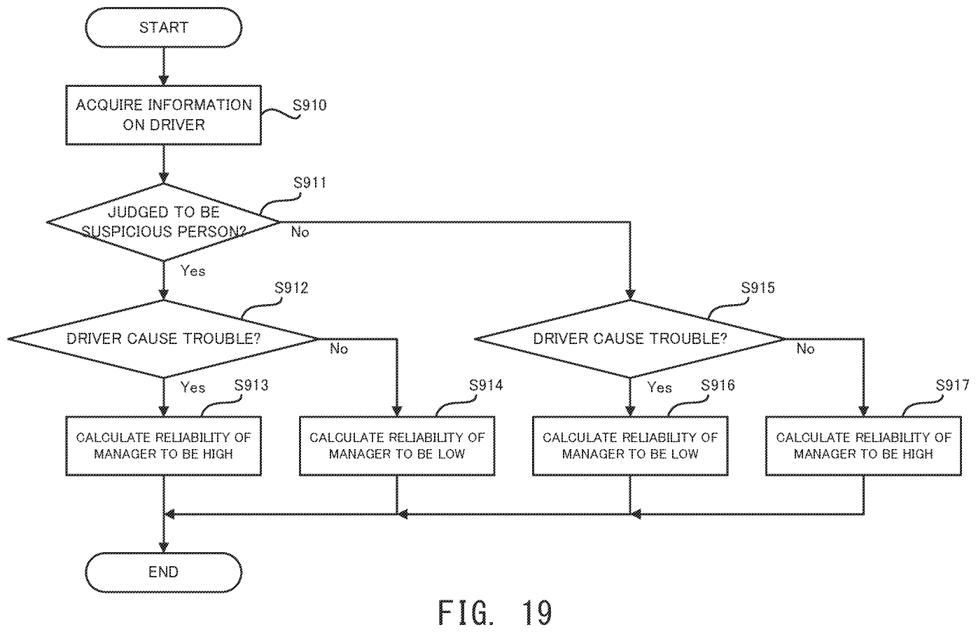

Next, with reference to FIG. 18, a configuration of the information processing apparatus 9 according to the ninth example embodiment will be described. FIG. 18 is a block diagram illustrating the configuration of the information processing apparatus 9 according to the ninth example embodiment. In the following description, the components already described carry the same reference numerals, and a detailed description thereof will be omitted.

As illustrated in FIG. 18, the information processing apparatus 9 according to the ninth example embodiment is different from the information processing apparatus 2 according to the second example embodiment (or the information processing apparatus 3 according to the third example embodiment) in that the arithmetic apparatus 21 includes a manager reliability calculation unit 921. Other features of the information processing apparatus 9 may be the same as those of the information processing apparatus 2 (or the information processing apparatus 3).

### (9-2) Manager Reliability Calculation Operation Performed by Information Processing Apparatus 9

Hereinafter, with reference to FIG. 19, a manager reliability calculation operation performed by the information processing apparatus 9 according to the ninth example embodiment will be described. FIG. 19 is a diagram illustrating a flow of the manager reliability calculation operation performed by the information processing apparatus 9 according to the ninth example embodiment.

The driver information acquisition unit 213 acquires the driver information (step S910). The driver information may include at least the driver caution information and a history of trouble on duty of the driver. The manager reliability calculation unit 921 determines whether or not the manager determines that the driver is a suspicious person in the roll call, with reference to the driver caution information (step S911). As a result of the determination in the step S911, when the manger determines the driver to be a suspicious person (the step S911: Yes), the manager reliability calculation unit 921 determines whether or not the driver has caused trouble on duty, with reference to the history of trouble on duty of the driver (step S912). As a result of the determination in the step S912, when the driver has caused trouble on duty (the step S912: Yes), the manager reliability calculation unit 921 recalculates the reliability of the manager concerned to be high (step S913). On the other hand, when the driver has not cause trouble on duty (the step S912: No), the manager reliability calculation unit 921 recalculates the reliability of the manager concerned to be low (step S914).

As a result of the determination in the step S911, when the manger does not determine the driver to be a suspicious person (the step S911: No), the manager reliability calculation unit 921 determines whether or not the driver has caused trouble on duty, with reference to the history of trouble on duty of the driver (step S915). As a result of the determination in the step S915, when the driver has caused trouble on duty (the step S915: Yes), the manager reliability calculation unit 921 recalculates the reliability of the manager concerned to be low (step S916). On the other hand, when the driver has not cause trouble on duty (the step S915: No), the manager reliability calculation unit 921 recalculates the reliability of the manager concerned to be high (step S917). The manager reliability calculation unit 921 may perform only the operations in the step S913 and the step S917, and may not performs the operations in the step S914 and the step S916. That is, the manager reliability calculation unit 921 may perform only an evaluation of increasing the reliability of the manager, and may not actively perform an evaluation of reducing the reliability of the manager.

### (9-3) Technical Effect of Information Processing Apparatus 9

In the ninth example embodiment, a method of evaluating the manager is proposed. Therefore, the information processing apparatus 9 according to the ninth example embodiment is also capable of supporting the realization of execution of an appropriate roll call by an appropriate manager, and is capable of supporting the appropriate management of execution of tasks.

### (10) Supplementary Notes

With respect to the example embodiment described above, the following Supplementary Notes are further disclosed.

### [Supplementary Note 1]

An information processing apparatus including:
a manager information acquisition unit that acquires manager reliability information indicating reliability of a manager who performs a roll call; and
an identification unit that identifies a manager who actually performs the roll call, as a caller, on the basis of the manager reliability information.

### [Supplementary Note 2]

The information processing apparatus according to Supplementary Note 1, further including a callee information acquisition unit that acquires callee reliability information indicating reliability of a callee who receives the roll call, wherein
the identification unit assigns a manager as the caller, to a callee, on the basis of the manager reliability information and the callee reliability information.

### [Supplementary Note 3]

The information processing apparatus according to Supplementary Note 2, wherein the identification unit assigns a manager with the reliability of the manager that is greater than or equal to a second predetermined value, as the caller, to the callee, when the reliability of the callee is less than or equal to a first predetermined value.

### [Supplementary Note 4]

The information processing apparatus according to Supplementary Note 2 or 3, wherein the identification unit assigns one of a plurality of managers, as the caller, to the callee, on the basis of a period when each of the plurality of managers is not assigned to the callee.

### [Supplementary Note 5]

The information processing apparatus according to any of Supplementary Notes 2 to 4, further including:
a biometric information acquisition unit that acquires biometric information on the callee; an estimation unit that estimates a state of the callee on the basis of the biometric information; and
a presentation control unit that presents the state estimated by the estimation unit, to the caller.

### [Supplementary Note 6]

The information processing apparatus according to any of Supplementary Notes 2 to 5, further including a determination unit that determines matters to be confirmed with the callee in the roll call, on the basis of the reliability of the callee.

### [Supplementary Note 7]

The information processing apparatus according to any of Supplementary Notes 2 to 6, wherein the identification unit permits the callee to perform a roll call that does not involve the caller, when the reliability of the callee is greater than or equal to a third predetermined value.

### [Supplementary Note 8]

The information processing apparatus according to any of Supplementary Notes 2 to 7, further including a notification unit that, when there is an abnormality in a vehicle scheduled to be driven by the callee, notifies a mechanic for the vehicle of the abnormality.

### [Supplementary Note 9]

The information processing apparatus according to any of Supplementary Notes 2 to 8, further including a display control unit that displays a route map of a vehicle driven by the callee, and that highlights at least one of a vehicle driven by a callee who is judged by the caller to be a suspicious person and a vehicle driven by a callee with low reliability.

### [Supplementary Note 10]

The information processing apparatus according to any of Supplementary Notes 2 to 9, further including:
a storage unit that stores therein a previous face image of the callee in association with the callee;
an authentication unit that acquires a current face image of the callee, and that authenticates the callee on the basis of the acquired current face image of the callee; and
a display control unit that acquires the previous face image of the callee authenticated by the authentication unit, from the storage unit, and that presents an image based on the current face image of the callee and the previous face image of the callee.

### [Supplementary Note 11]

The information processing apparatus according to Supplementary Note 10, wherein the display control unit superimposes and displays a difference between the current face image and the previous face image of the callee, on at least one of the current face image and the previous face image of the callee.

### [Supplementary Note 12]

A task management system including:
a callee terminal including a communication unit that communicates with an external apparatus, and an image generation unit that generates a current face image of a callee by imaging the callee;
an information processing apparatus including a communication unit that communicates with an external apparatus, an image acquisition unit that acquires the current face image of the callee from the image generation unit through the communication unit, and the information processing apparatus according to Supplementary Note 10 or 11; and
a manager terminal including a communication unit that communicates with an external apparatus, and a display that is controlled by the display control unit through the communication unit and that displays a screen for the manager.

### [Supplementary Note 13]

An information processing method including:
acquiring manager reliability information indicating reliability of a manager who performs a roll call; and
identifying a manager who actually performs the roll call, as a caller, on the basis of the manager reliability information.

### [Supplementary Note 14]

A recording medium on which a computer program that allows a computer to execute an information processing method is recorded, the information processing method including:
acquiring manager reliability information indicating reliability of a manager who performs a roll call; and
identifying a manager who actually performs the roll call, as a caller, on the basis of the manager reliability information.

At least a part of the constituent components of each of the example embodiments described above can be combined with at least another part of the constituent components of each of the example embodiments described above, as appropriate. A part of the constituent components of each of the example embodiments described above may not be used. Furthermore, to the extent permitted by law, all the references (e.g., publications) cited in this disclosure are incorporated by reference as a part of the description of this disclosure.

This disclosure is not limited to the examples described above and is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

1, 2, 3, 4, 5, 6, 7, 8, 9 Information processing apparatus
11, 211 Manager information acquisition unit
12, 212 Identification unit
21 Arithmetic apparatus
213 Driver information acquisition unit
414 Biometric information acquisition unit
415 Authentication unit
416 Presentation control unit
417 Estimation unit
519 Determination unit
720 Notification control unit
921 Manager reliability calculation unit
22 Storage apparatus
23 Communication apparatus
24 Input apparatus
25 Output apparatus
26 Data bus
100, 500, 800 Operating management system
101 Manager terminal
102 Driver terminal

What is claimed is:

1. An information processing apparatus comprising:
at least one memory that is configured to store instructions; and
at least one processor that is configured to execute the instructions to:
acquire manager reliability information indicating reliability of a manager who performs a roll call; and
identify a manager who actually performs the roll call, as a caller, on the basis of the manager reliability information.

2. The information processing apparatus according to claim 1, wherein the at least one processor is configured to execute the instructions to:
acquire callee reliability information indicating reliability of a callee who receives the roll call; and
assign a manager as the caller, to a callee, on the basis of the manager reliability information and the callee reliability information.

3. The information processing apparatus according to claim 2, wherein the at least one processor is configured to execute the instructions to assign a manager with the reliability of the manager that is greater than or equal to a second predetermined value, as the caller, to the callee, when the reliability of the callee is less than or equal to a first predetermined value.

4. The information processing apparatus according to claim 2, wherein the at least one processor is configured to execute the instructions to assign one of a plurality of managers, as the caller, to the callee, on the basis of a period when each of the plurality of managers is not assigned to the callee.

5. The information processing apparatus according to claim 2, wherein the at least one processor is configured to execute the instructions to:
acquire biometric information on the callee;
estimate a state of the callee on the basis of the biometric information; and
present the state estimated, to the caller.

6. The information processing apparatus according to claim 2, wherein the at least one processor is configured to execute the instructions to determine matters to be confirmed with the callee in the roll call, on the basis of the reliability of the callee.

7. The information processing apparatus according to claim 2, wherein the at least one processor is configured to execute the instructions to permit the callee to perform a roll call that does not involve the caller, when the reliability of the callee is greater than or equal to a third predetermined value.

8. The information processing apparatus according to claim 2, wherein the at least one processor is configured to execute the instructions to, when there is an abnormality in a vehicle scheduled to be driven by the callee, notify a mechanic for the vehicle of the abnormality.

9. The information processing apparatus according to claim 2, wherein the at least one processor is configured to execute the instructions to display a route map of a vehicle driven by the callee, and highlight at least one of a vehicle driven by a callee who is judged by the caller to be a suspicious person and a vehicle driven by a callee with low reliability.

10. The information processing apparatus according to claim 2, wherein the at least one processor is configured to execute the instructions to:
store therein a previous face image of the callee in association with the callee;
acquire a current face image of the callee, and authenticate the callee on the basis of the acquired current face image of the callee; and
acquire the previous face image of the callee authenticated, from the storage unit, and present an image based on the current face image of the callee and the previous face image of the callee.

11. The information processing apparatus according to claim 10, wherein the at least one processor is configured to execute the instructions to superimpose and display a difference between the current face image and the previous face image of the callee, on at least one of the current face image and the previous face image of the callee.

12. A task management system comprising:
a callee terminal including:
at least one memory that is configured to store instructions; and
at least one processor that is configured to execute the instructions to:
communicate with an external apparatus; and
generate a current face image of a callee by imaging the callee;
an information processing apparatus including:
at least one memory that is configured to store instructions; and
at least one processor that is configured to execute the instructions to:
acquire manager reliability information indicating reliability of a manager who performs a roll call;
acquire callee reliability information indicating reliability of a callee who receives the roll call;
assign a manager who actually performs the roll call as the caller, to a callee, on the basis of the manager reliability information and the callee reliability information;
store a previous face image of the callee in association with the callee, in a storage unit;
communicate with the callee terminal;
acquire the current face image of the callee from the callee terminal, and authenticate the callee on the basis of the acquired current face image of the callee; and
acquire the previous face image of the callee authenticated, from the storage unit, and present an image based on the current face image of the callee and the previous face image of the callee; and
a manager terminal including:
at least one memory that is configured to store instructions; and
at least one processor that is configured to execute the instructions to:
communicate with the information processing apparatus, and
display a screen to present the image based on the current face image of the callee and the previous face image of the callee for the manager.

13. An information processing method comprising:
acquiring manager reliability information indicating reliability of a manager who performs a roll call; and
identifying a manager who actually performs the roll call, as a caller, on the basis of the manager reliability information.

14. (canceled)
